(19) United States
(12) Patent Application Publication
(10) Pub. No.: US 2026/0079358 A1
(43) Pub. Date: Mar. 19, 2026

(54) SYSTEMS, METHODS, AND DEVICES FOR SERVICING AND/OR MAINTAINING WEARABLE DEVICES

(71) Applicant: Meta Platforms Technologies, LLC, Menlo Park, CA (US)

(72) Inventors: Tianren Xu, San Jose, CA (US); Matthew Aaron, San Francisco, CA (US); Lisa Dlima, San Francisco, CA (US); Ankur Gupta, Sunnyvale, CA (US); Zachary Ian Howard, San Francisco, CA (US); Justin Leong, San Francisco, CA (US); Akis Lyrintzis, Sunnyvale, CA (US); Lauren Akemi Hamamoto Donegan Ryan, Kirkland, WA (US); Steve Soto Mejias, Vancouver, WA (US); Michael Xingyi Yu, Mountain View, CA (US)

(21) Appl. No.: 19/330,813

(22) Filed: Sep. 16, 2025

Related U.S. Application Data
(60) Provisional application No. 63/695,321, filed on Sep. 16, 2024.
(60) Provisional application No. 63/792,822, filed on Apr. 22, 2025.

(51) Int. Cl. G02C 11/00; G02B 27/01; G02C 5/14; G02C 13/00; H01M 50/24; H01M 50/264; H01M 50/271

(52) U.S. Cl. CPC G02C 11/10; G02B 27/0176; G02C 5/146; G02C 13/001; G02C 13/006; H01M 50/24; H01M 50/264; H01M 50/271; G02B 2027/0169; G02B 2027/0178; G02C 2200/04; G02C 2200/06; H01M 2220/30

(57) ABSTRACT

The present disclosure is directed to providing an optical device, such as a pair of smart glasses. A temple arm of a pair of smart glasses includes a battery disposed within a cavity of the temple arm. The temple arm further includes a cover that encloses the battery located within the cavity of the temple arm. Moreover, the temple arm includes a seal that at least partially secures the cover to the temple arm and is configured to prevent moisture and debris ingress into the cavity. Furthermore, the seal includes an adhesive section that couples the cover and the temple arm and a reusable gasket section removably coupled to the cover and the temple arm. The reusable gasket section is configured to facilitate removal of the cover from the temple arm for replacing the battery.

### PRIORITY AND RELATED APPLICATIONS

This application claims priority to U.S. Provisional Patent Application No. 63/695,321, filed Sep. 16, 2024, and to U.S. Provisional Patent Application No. 63/792,822, filed Apr. 22, 2025, each of which is hereby incorporated by reference in its entirety.

### TECHNICAL FIELD

The present disclosure relates generally to optical devices, including, but not limited to, optical devices with electronic features that require service and/or maintenance during a lifespan of the optical device.

### BACKGROUND

Electronic devices are widely used in artificial reality and other vision-based applications, such as eyewear and/or glasses. For such devices, produce serviceability is an important factor. An imperative for product serviceability is increasingly underscored by regulatory bodies and users globally. For instance, the European Union (EU) is instituting a mandate requiring batteries to be user-replaceable in all electronic devices. Many conventional products feature enclosures sealed through adhesive or welding methods, ensuring high levels of water and dust protection. However, such designs do not allow for an end-user to open the enclosure(s) housing the battery of the device. Conversely, alternative sealing mechanisms, such as gaskets, require substantial space within the device. This issue is particularly pronounced for devices with compact form factors, such as smart glasses.

Some conventional devices use an adhesive ribbon that is attached to a surface of the device with a battery disposed on the adhesive ribbon, causing the adhesive ribbon to interpose between the surface and the battery. When the adhesive ribbon is pulled, the battery is dislodged from the device. However, to dispose the battery within the device, the adhesive ribbon must be placed properly by the user between the surface and the battery, which is complicated given the limited space to manipulate the adhesive ribbon and the battery. Conventional devices further require the user place the adhesive ribbon back properly to allow it to take the batteries out.

### SUMMARY

The present disclosure addresses the above-identified shortcomings. The present disclosure provides various implementations for enabling battery serviceability in compact electronic devices, particularly smart glasses, while maintaining device integrity and user-friendliness.

Some embodiments described herein include a temple arm of an optical device that includes a battery disposed within a cavity, enclosed by a cover secured with a hybrid seal. The seal may comprise an adhesive section that couples the cover to the temple arm and a reusable gasket section that facilitates removal. This approach may provide several advantages: the adhesive section maintains strong sealing around most of the perimeter while the gasket section creates an intentional access point for battery replacement. The design may allow the cover to be removed and reattached multiple times (potentially over 1,000 cycles) without compromising moisture and debris protection. The seal may be recessed at the gasket section to accommodate prying tools, enabling user-friendly access without specialized equipment.

Some embodiments described herein provide space optimization through a shared mounting system where both the battery and removable cover interface with the same slots within the temple arm cavity. The battery may include spring clips that engage with slots in the cavity, while the cover may include notches that interface with the same slots in different locations. This configuration may maximize internal space utilization, potentially allowing for larger batteries or additional components within the constrained temple arm volume.

An example battery removal solution involves a tab fixedly coupled to the battery surface that may eliminate the need for proper user placement of removal aids. The tab may be configured to compress spring clips during removal, automatically disengaging the battery from the cavity. This approach may reduce user error and tool requirements while providing a convenient handle for battery transport and installation.

For electrical connections, the disclosure presents anode pack tabs that combine electrical connectivity with mechanical alignment in a single component. These may include pressed-in pin inserts or formed sheet metal features that provide alignment capabilities while maintaining electrical connection between the cell and protection control module (PCM). This integration may address space constraints by eliminating separate alignment components and may ensure precise positioning of electrical contacts to prevent short circuits.

The disclosure also describes release latch systems with slidable portions and flat springs that may provide controlled access to battery compartments. These mechanisms may be operable by finger or specialized tools and may include protrusions that interact with the temple arm to release the latch when activated.

Battery doors may operate between open and closed states, where the closed state applies sufficient force to secure charging contacts to the battery. Spring-loaded contacts may provide automatic battery ejection when the door is removed, facilitating easy battery replacement.

These solutions collectively address the challenges of regulatory compliance, space optimization, user accessibility, and manufacturing efficiency while maintaining the aesthetic and functional requirements of compact wearable devices.

(A1) In accordance with some embodiments, a pair of smart glasses includes a temple arm. The temple arm includes a battery, a cover, and a seal. The battery is disposed within a cavity of the temple arm. Moreover, the cover encloses the battery located within the cavity of the temple arm. Furthermore, the seal at least partially secures the cover to the temple arm. The seal is configured to prevent moisture and debris ingress into the cavity. Additionally, the seal includes a section that is configured to facilitate removal of the cover from the temple arm for replacing the battery. In some embodiments, the seal includes an adhesive section and a gasket section, where the adhesive section semi-permanently bonds the cover and the temple arm and the reusable gasket section is removably coupled to the cover and/or the temple arm. In some embodiments, the gasket section is configured to facilitate removal of the cover from the temple arm for replacing the battery.

(A2) In some embodiments of (A1), the seal comprises an adhesive and a reusable gasket material.

(A3) In some embodiments of any one of (A1)-(A2), the seal comprises at least an adhesive disposed around a remaining section of a perimeter of the cover and at least a gasket at the section that facilitates removal of the cover. In some embodiments, the adhesive section is disposed around a section of a perimeter of the cover other than the gasket section that facilitates removal of the cover. For example, the adhesive section is disposed around most (e.g., 55%, 75%, 90%, 95%, 99%, etc.) of the perimeter the cover and the remainer of the perimeter is sealed via the gasket. In some embodiments, each end of the adhesive section is coupled to a gasket section.

(A4) In some embodiments of any one of (A1)-(A3), the section (e.g., the gasket section) that facilitates removal of the cover does not comprise an adhesive.

(A5) In some embodiments of any one of (A1)-(A4), the seal is recessed within the temple arm at the section that is configured to facilitate removal of the cover such that a pry tool can be inserted into the section for aiding in removing the cover.

(A6) In some embodiments of any one of (A1)-(A5), the seal is constructed of a gasket material at the section that is configured to facilitate removal of the cover to aid in removal of the cover.

(A7) In some embodiments of any one of (A1)-(A6), the cover is configured to be removed and attached at least 1,000 times before moisture and debris prevention of the seal is comprised.

(A8) In some embodiments of any one of (A1)-(A7), the battery is configured to be removed after the cover is removed, such that a replacement battery can be installed.

(A9) In some embodiments of any one of (A1)-(A8), the cover partially secures to the temple arm via a clip.

(A10) In some embodiments of any one of (A1)-(A9), the cover comprises at least two pieces.

(A11) In some embodiments of any one of (A1)-(A10), the temple arm includes another battery.

(A12) In some embodiments of any one of (A1)-(A11), an indication is located on the cover indicating where to initiate removal of the battery.

(A13) In some embodiments of any one of (A1)-(A12), the temple arm is configured to receive a tool at the section (e.g., the gasket section) that is configured to facilitate removal of the cover without damaging the temple arm and/or cover upon removal of the cover from the temple arm.

(A14) In some embodiments of any one of (A1)-(A12), the pair of smart glasses further comprise a slot (e.g., a first slot) in a first region within the cavity of the temple arm configured to secure the battery within the cavity and to secure the cover to the temple arm.

(A15) In some embodiments of (A14), the pair of smart glasses further comprise another slot (e.g., a second slot) in a second region within the cavity of the temple arm also configured to secure the battery with the cavity and to secure the cover to the temple arm.

(A16) In some embodiments of any one of (A14)-(A15), the battery includes one or more spring clips for interfacing with the slot and/or the other slot.

(A17) In some embodiments of any one of (A14)-(A16), the cover includes one or more notches for interfacing with the slot and/or the other slot.

(A18) In some embodiments of any one of (A1)-(A17), the battery is configured to be removed by pulling a tab, compressing a spring clip with the tab as the tab is pulled, and continuing to pull on the tab until the battery is removed from the cavity. In some embodiments, the tab is a free end of a tape connected to the battery. In some embodiments, the battery is disengaged from the cavity in response to compressing the spring clip with the tab (e.g., the spring clip keeps the battery engaged).

(A19) In some embodiments of any of (A1)-(A18), the cover is configured to operate between an open state in which the cover does not apply sufficient force to the battery for securing a plurality of charging contacts within the cavity to the battery and a closed state in which the cover applies sufficient force to the battery for securing the plurality of charging contacts to the battery. In some embodiments, the battery is configured to contact the plurality of charging contacts to provide power to the smart glasses

(B1) In another aspect, a pair of augmented-reality glasses that includes a temple arm. The temple arm includes a battery located within a cavity of the temple arm. The temple arm further includes a cover that encloses the battery located within the cavity of the temple arm. Moreover, the temple arm includes a seal that at least partially secures the cover to the temple arm. The seal is configured to prevent moisture and debris ingress into the cavity, and includes a section that is configured to facilitate removal of the cover from the temple arm for replacing the battery.

(C1) In another aspect, a method of replacing a battery in a temple arm of a pair of smart glasses is provided. The method includes pulling a tab, wherein the tab is a free end of a tape connected to the battery. The method further includes compressing a spring clip with the tab as the tab is pulled, disengaging the battery from a cavity in the temple arm. Additionally, the method includes removing the battery from the cavity by continuing to pull on the tab. Furthermore, the method includes inserting a new battery, the new battery comprising a new tab connected to the new battery.

(D1) In another aspect, a temple arm of a pair of smart glasses includes a battery located within a cavity of a temple arm. Moreover, the temple arm includes a plurality of charging contacts within the cavity, in which the battery is configured to contact the plurality of charging contacts to provide power to the pair of smart glasses. Furthermore, the temple arm includes a battery door located on the temple arm that encloses the battery within the cavity of the temple arm. The battery door operates between (i) an open state in which the battery door does not apply sufficient force to the battery for securing the plurality of charging contacts to the battery, and (ii) a closed state in which the battery door applies sufficient force to the battery for securing the plurality of charging contacts to the battery.

(D2) In some embodiments of (D1), the charging contacts are spring loaded, such that the battery is ejected from the cavity of the temple arm when the battery door is removed.

(E1) In another aspect, a temple arm of a pair of smart glasses includes a cavity cut into the temple arm. Moreover, the temple arm includes a battery removably housed within the cavity. Additionally, the temple arm includes a removable door configured to cover an opening of the cavity, the door having a release latch. The latch includes a slidable portion, and a flat spring connected to the slidable portion, in which the flat spring is compressed when the slidable portion is moved. The latch further includes a protrusion that interacts with the temple arm and is connected to the flat spring such that when the flat spring is compressed, the protrusion moves relative to the temple arm to release the latch.

(E2) In some embodiments of (E1), the slidable portion of the latch is configured to be operated by a finger.

(E3) In some embodiments of (E1) or (E2), the slidable portion of the latch is configured to be operated by a specialized tool.

(F1) In another aspect, a method comprises using a battery and/or a temple arm of an optical device configured in accordance with any of (A1)-(E3).

(G1) In another aspect, a non-transitory, computer-readable storage medium includes executable instructions that, when executed by one or more processors, cause the one or more processors to perform or cause performance of an of the methods described herein (e.g., the method of (F1)).

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 illustrates an exemplary implementation of an optical device in accordance with some exemplary embodiments of the present disclosure.

FIG. 2A illustrates a system architecture of an optical device in accordance with some exemplary embodiments of the present disclosure.

FIG. 2B illustrates an example optical device (e.g., a pair of augmented-reality glasses) that illustrate example locations in which removable batteries can be placed, in accordance with some exemplary embodiments of the patent disclosure.

FIG. 3 illustrates a view of an optical device including a temple arm in accordance with some exemplary embodiments of the present disclosure.

FIG. 4 is another view of an optical device including a temple arm in accordance with some exemplary embodiments of the present disclosure.

FIG. 5 is a view of an optical device including a first side of a battery that is removed from the optical device in accordance with some exemplary embodiments of the present disclosure.

FIG. 6 is a view of an optical device including a second side of a battery that is removed from the optical device in accordance with some exemplary embodiments of the present disclosure.

FIG. 7 is a view of an optical device including a battery that is disposed in the optical device in accordance with some exemplary embodiments of the present disclosure.

FIG. 8A is a view of a battery for an optical device in a locked position in accordance with some embodiments of the present disclosure.

FIG. 8B is a view of the battery of FIG. 8A in an unlocked position.

FIGS. 9, 10, 11, and 12 collectively illustrate a process for removing a battery from an optical device in accordance with some embodiments of the present disclosure.

FIG. 13A is a view of an actuator of a battery for an optical device in accordance with some embodiments of the present disclosure.

FIG. 13B is a view of another actuator of a battery for an optical device in accordance with some embodiments of the present disclosure.

FIGS. 14, 15, and 16 collectively illustrate another process for removing a battery from an optical device in accordance with some embodiments of the present disclosure.

FIG. 17 illustrates a partially exploded view of a battery for an optical device in accordance with some embodiments of the present disclosure.

FIG. 18 is a rear view of the battery of FIG. 17.

FIG. 19 is a view of yet another actuator of a battery for an optical device in accordance with some embodiments of the present disclosure.

FIG. 20 is a view of a temple arm and one or more configured to electronically couple a battery and a processor of the temple arm in accordance with some embodiments of the present disclosure.

FIG. 21A illustrates a temple arm on a pair of smart glasses that are configured to receive a removable battery, in accordance with some embodiments of the present disclosure.

FIG. 21B illustrates that both of the spring clip of the battery and the notches of the removable cover are both interfacing with the slot, in accordance with some embodiments of the present disclosure.

FIGS. 22A, 22B, 22C-1, and 2C-2 illustrate example MR and AR systems, in accordance with some embodiments.

FIGS. 23A and 23B illustrate example battery components in accordance with some embodiments.

FIG. 23C illustrates an example connector with electrical contacts and alignment features in accordance with some embodiments.

FIG. 23D illustrates an example anode component in accordance with some embodiments.

FIGS. 23E and 23F illustrate example anode components with alignment features in accordance with some embodiments.

FIG. 23G illustrates an example battery retention system in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION OF THE INVENTION

The present disclosure addresses critical technical challenges in designing serviceable electronic devices, particularly compact wearable devices such as smart glasses, that must comply with emerging regulatory requirements for user-replaceable batteries while maintaining device integrity and performance. Traditional electronic devices rely on permanent sealing methods such as adhesives or welding to achieve high levels of moisture and dust protection, but these approaches prevent end-users from accessing internal components like batteries. Conversely, conventional serviceable designs using gaskets require substantial internal space, which is particularly problematic for compact form factors like smart glasses where space constraints can reduce battery capacity by up to 50%. The present disclosure provides solutions that enable battery serviceability while minimizing impact on device size, sealing performance, and aesthetic design. These solutions include hybrid sealing systems that combine permanent adhesive sections with removable gasket sections, integrated battery and cover mounting systems that maximize space utilization, and compact electrical connection systems that combine alignment features with electrical connectivity in single components. An example temple arm of a pair of smart glasses includes a battery disposed within a cavity of the temple arm, a cover that encloses the battery, and a seal that prevents moisture and debris ingress while facilitating controlled access for battery replacement through strategically designed removable sections.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogram EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Example Optical Devices

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

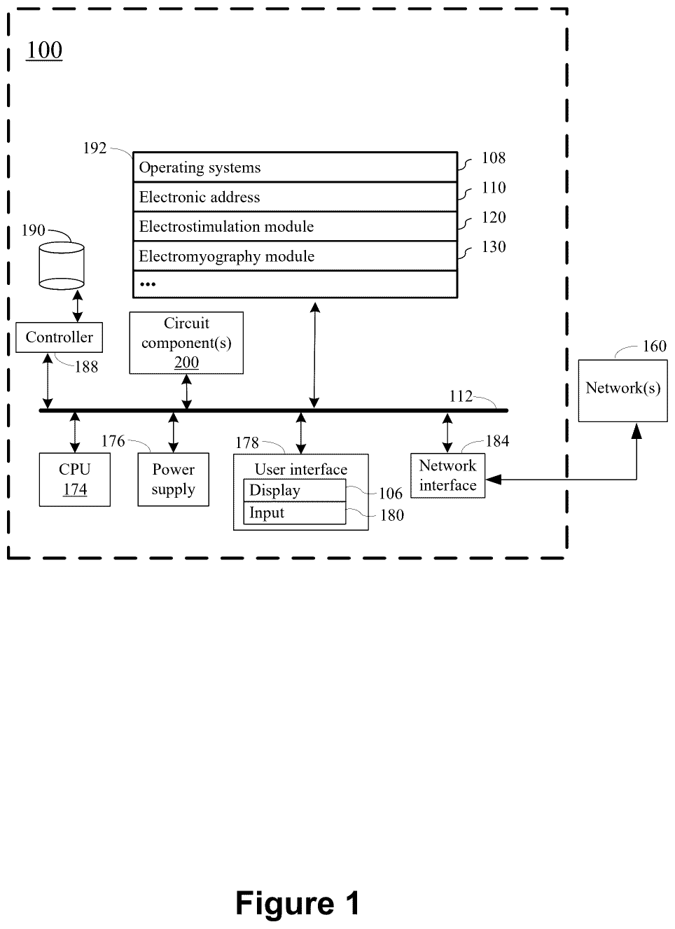

In the present disclosure, unless expressly stated otherwise, descriptions of devices and systems will include implementations of one or more optical devices. For instance, and for purposes of illustration in FIG. 1, an optical device 100 is represented as single device that includes all the functionality of the optical device 100. However, the present disclosure is not limited thereto. For instance, the functionality of the optical device 100 may be spread across any number of networked computers and/or reside on each of several networked computers and/or by hosted on one or more virtual machines and/or containers at a remote location accessible across a communications network (e.g., networks 160). One skilled in the art of the present disclosure will appreciate that a wide array of different computer topologies is possible for the optical device 100, and other devices and systems of the preset disclosure, and that all such topologies are within the scope of the present disclosure. As such, the exemplary topology shown in FIG. 1 merely serves to describe the features of an embodiment of the present disclosure in a manner that will be readily understood to one skilled in the art.

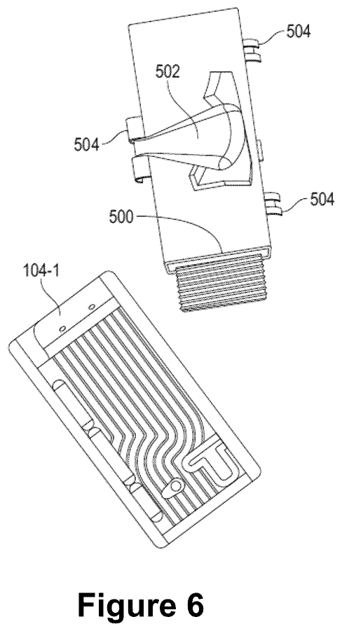

Referring to FIGS. 1 through 10, an exemplary optical device is provided. More specifically, FIG. 1 depicts a block diagram of an optical device (e.g., optical device 100) according to some embodiments of the present disclosure.

In some embodiments, the communication networks 160 optionally includes the Internet, one or more local area networks (LANs), one or more wide area networks (WANs), other types of networks, or a combination of such networks.

Examples of communication networks 160 include the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

In various embodiments, the optical device 100 includes one or more processing units (CPUs) 174, a network or other communications interface 184, and a memory 192.

The memory 192 includes high-speed random-access memory, such as DRAM, SRAM, DDR RAM, or other random-access solid-state memory devices, and optionally also includes non-volatile memory, such as one or more magnetic disk storage devices, optical disk storage devices, flash memory devices, or other non-volatile solid state storage devices. The memory 192 may optionally include one or more storage devices remotely located from the CPU(s) 174. The memory 192, or alternatively the non-volatile memory device(s) within memory 192, includes a non-transitory computer readable storage medium. Access to memory 192 by other components of the optical device 100, such as the CPU(s) 174, is, optionally, controlled by a controller. In some embodiments, the memory 192 can include mass storage that is remotely located with respect to the CPU(s) 174. In other words, some data stored in the memory 192 may in fact be hosted on devices that are external to the optical device 100, but that can be electronically accessed by the optical device 100 over an Internet, intranet, or other form of communication network 160 or electronic cable using communication interface 184.

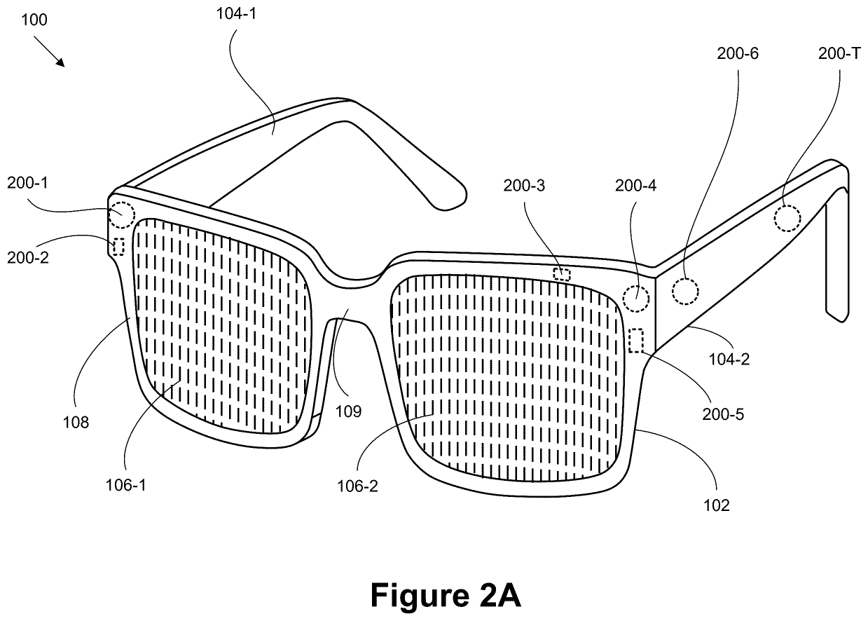

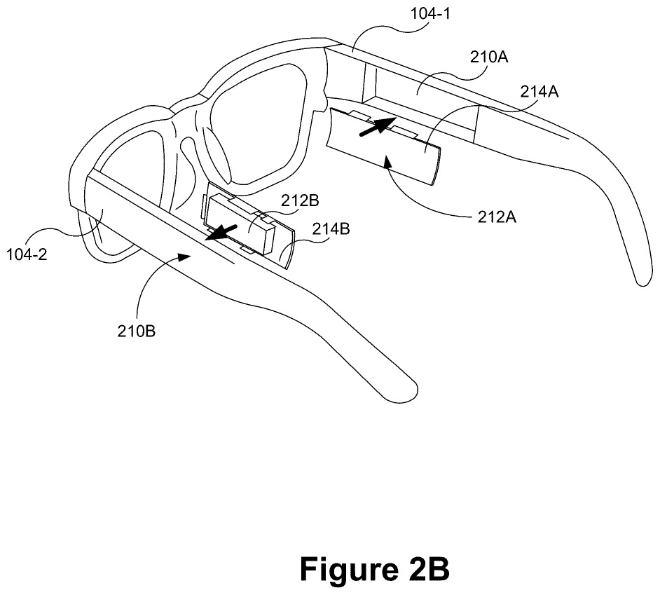

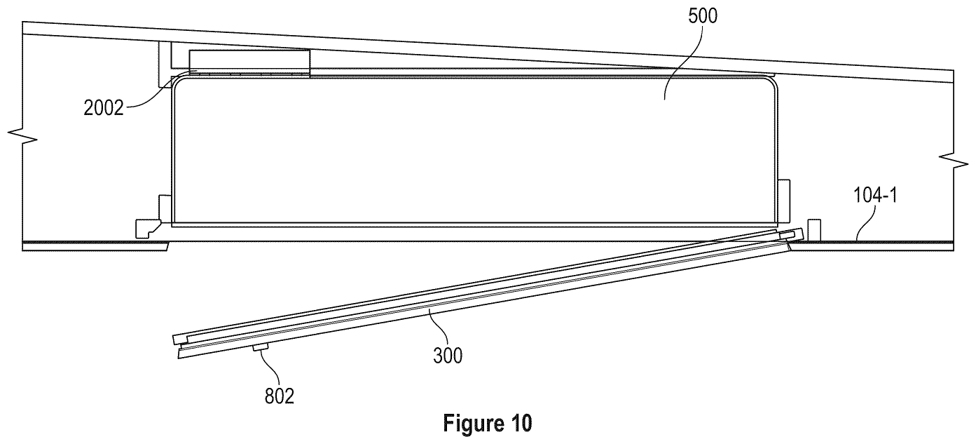

In some embodiments, the memory 192 of the optical device 100 stores:
an optional operating system 108 (e.g., ANDROID, iOS, DARWIN, RTXC, LINUX, UNIX, OS X, WINDOWS, or an embedded operating system such as Vx Works) that includes procedures for handling various basic system services;
an electronic address 110 associated with the optical device 100 that identifies the optical device 100;
optionally, an electrostimulation module 120 that stores one or more logic functions (e.g., one or more logic functions of FIG. 10) for generating and/or communicating one or more electronic signals to one or more circuit components (e.g., circuit component 200-1 of FIG. 2A, circuit component 200-2 of FIG. 2A, circuit component 200-3 of FIG. 2A, circuit component 200-T of FIG. 2A, etc.); and
optionally, an electromyography module 130 that stores one or more logic functions (e.g., one or more logic functions of FIG. 10) for evaluation one or more electronic signals received from the one or more circuit components (e.g., circuit component 200-1 of FIG. 2A, circuit component 200-2 of FIG. 2A, circuit component 200-3 of FIG. 2A, circuit component 200-T of FIG. 2A, etc.).

In some embodiments, an electronic address 110 is associated with the optical device 100. The electronic address 110 is utilized to identify the optical device 100 at least uniquely from other devices and components, such as though communicated with through the communications network 160.

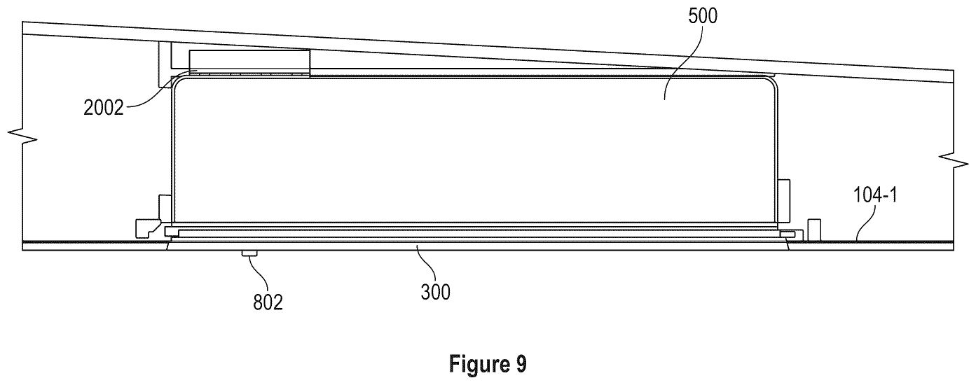

Each of the above identified modules and applications correspond to a set of executable instructions for performing one or more functions described above and the methods described in the present disclosure (e.g., the computer-implemented methods and other information processing methods described herein; method 900 of FIG. 9; etc.). These modules (e.g., sets of instructions) need not be implemented as separate software programs, procedures or modules, and thus various subsets of these modules are, optionally, combined or otherwise re-arranged in various embodiments of the present disclosure. In some embodiments, the memory 192 optionally stores a subset of the modules and data structures identified above. Furthermore, in some embodiments, the memory 192 stores additional modules and data structures not described above.

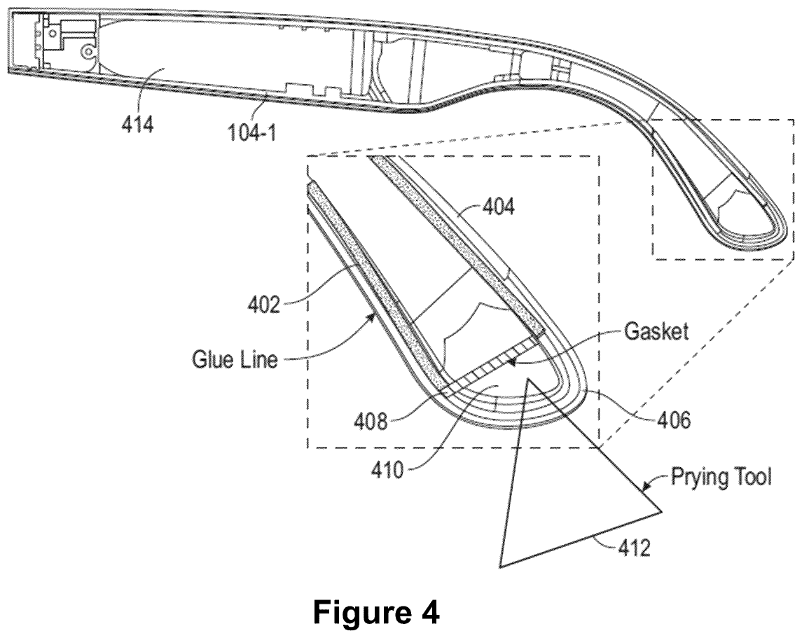

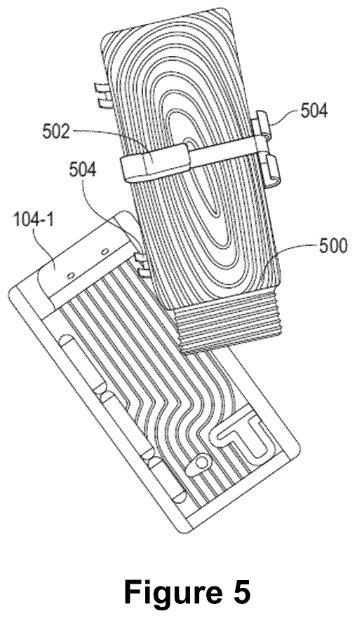

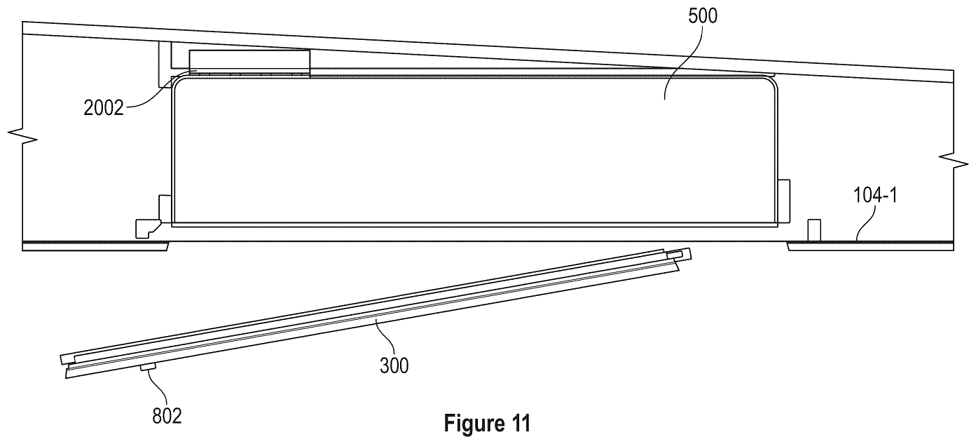

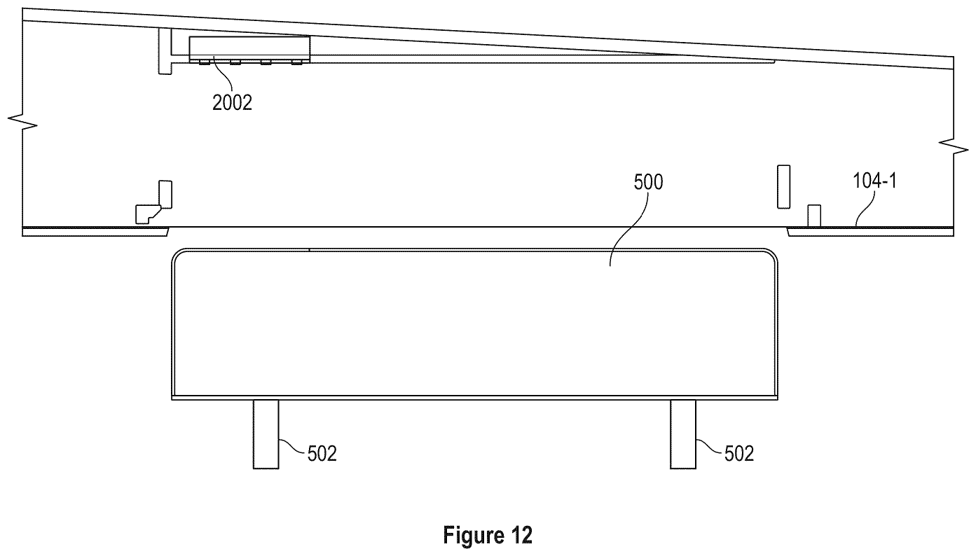

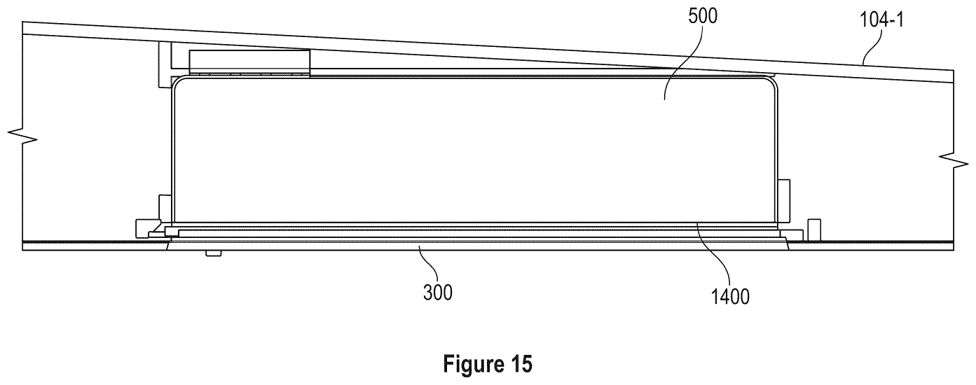

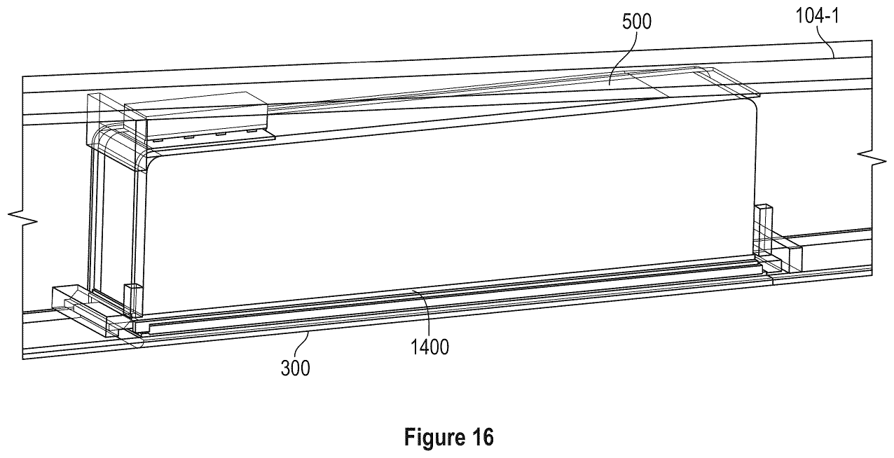

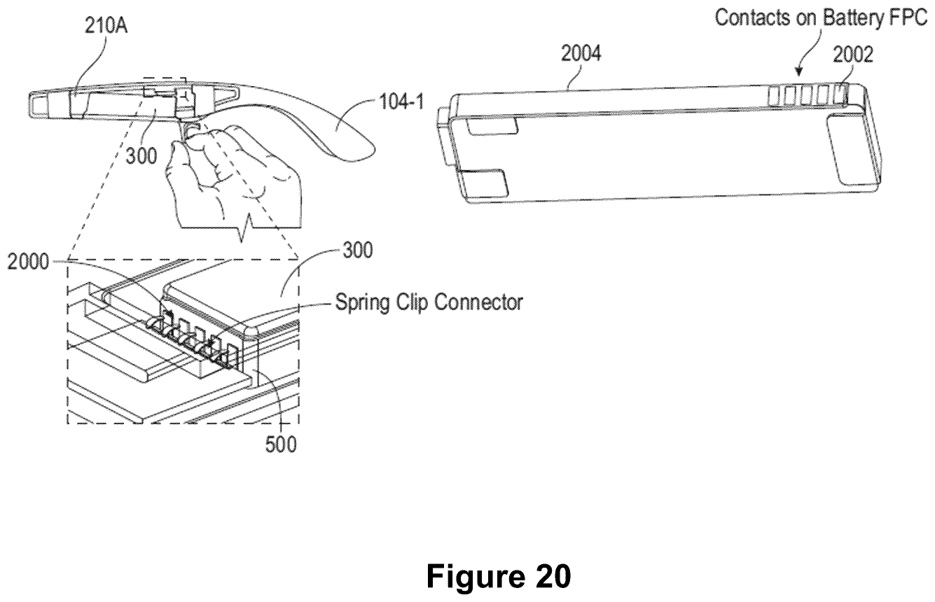

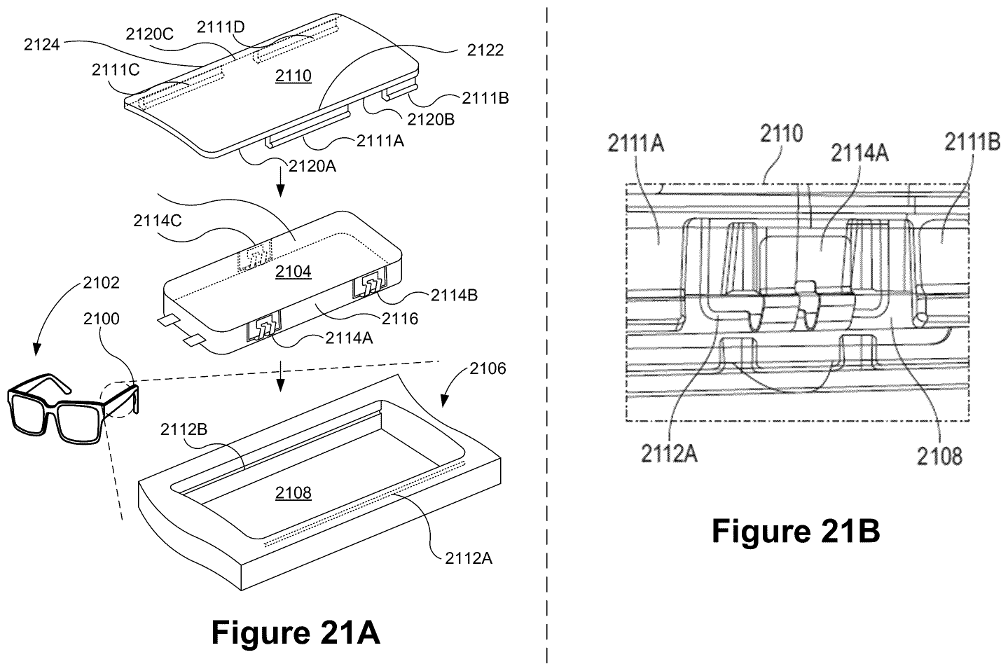

Many concepts are discussed in this application and a general overview of these concepts is described herein and are related to (1) locations of battery doors, (2) battery mounting options, (3) battery door retention, and (4) battery retention methods. Details of battery door locations are discussed in reference to at least FIGS. 2B, 3 and 4, which describe at least two battery door locations. Details of battery mounting are discussed in reference to at least FIGS. 20-21, which include battery mounting options that include integrated battery doors and mounting options that include battery doors that are separate from the battery. Details of battery door retention techniques are discussed in reference to at least FIGS. 4, 8A-19, which include at least glue retention, gasket retention (with or without clips), and lock mechanisms (with and without gaskets). These example door retention techniques are compatible with the battery mounting options discussed, along with the any of the battery door locations discussed. Details of battery retention techniques are discussed in reference to at least FIGS. 5-7, which include at least removable PSA, snaps, and removal ribbons.

While this roadmap generally describes the overview of the examples described herein, one skilled in the art would appreciate that the embodiments described in each figure are meant to be interchangeable, and features described in reference to any one of the figures are intended to be combined or replaced with other features described in reference to any other figure in this application.

It should be appreciated that the optical device 100 of FIG. 1 is only one example of an optical device 100, and that optical device 100 optionally has more or fewer components than shown, optionally combines two or more components, or optionally has a different configuration or arrangement of the components. The various components shown in FIG. 1 are implemented in hardware, software, firmware, or a combination thereof, including one or more signal processing and/or application specific integrated circuits.

In some embodiments, the optical device 100 is a garment that is worn by a subject, such as around a wrist, hand, finger, neck, waist, ankle or combination thereof of the subject. However, the present disclosure is not limited thereto. For instance, in some embodiments, the optical device 100 is a garment accessory worn but the subject, such as a pair of glasses (e.g., smart glasses), a pair of googles, a helmet, or a wristwatch (e.g., smart watch) worn by the subject.

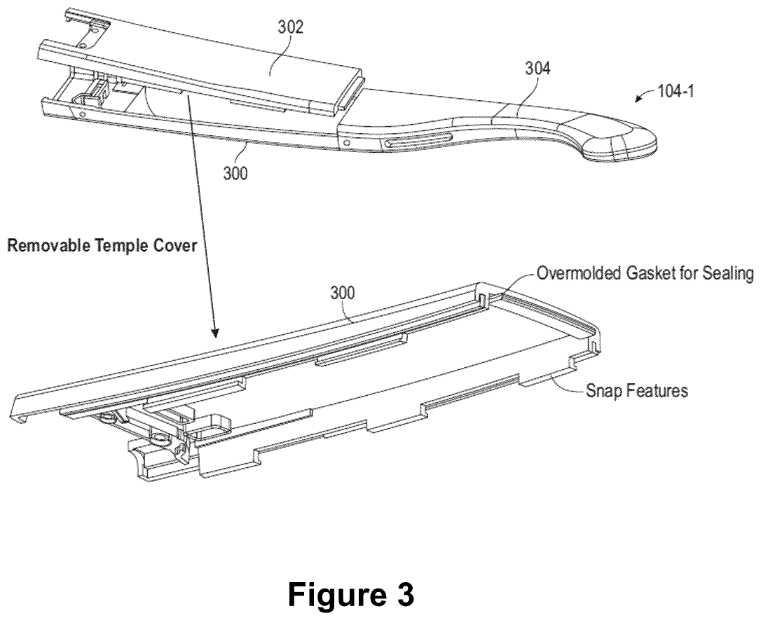

Accordingly, the optical device 100 includes a frame (e.g., frame 102 of FIG. 2A, frame 102 of FIG. 3, frame 102 of FIG. 4, frame 102 of FIG. 5A, frame 102-1 of FIG. 5B, frame portion 102-2 of FIG. 5, etc.), which allows the wearer of the optical device 100 to adorn the optical device 100 during a variety of activities. For instance, referring to FIG. 2A, the optical device 100 includes a frame 102 including a rim, a bridge 109, and a pair of temples 104. However, the present disclosure is not limited thereto. In some embodiments, the frame 102 includes a plurality of frame portions, such as a first frame portion 102-1 and/or a second frame portion 102-2 of FIG. 5B. In some embodiments, the first frame portion 102-1 and the second frame portion 102-2 couple together through a fastener, such as a push fastener or pin fastener, which allows for forming one or more channels, one or more grooves, one or more cavities, or the like disposed interposing between the first frame portion 102-1 and the second frame portion 102-2. Moreover, in some such embodiments, the frame 102 is configured to accommodate one or more circuits, which allows for the optical device 100 to perform a variety of computational functions when being worn by the wearer. For instance, in some embodiments, the frame 102 includes one or more openings or apertures (e.g., aperture 704 of FIG. 7A) that is configured to expose an exterior surface of an object to an environment.

In some embodiments, the optical device 100 includes a circuit that further includes two or more circuit components 200 accommodated by the frame 102. In some embodiments, the circuit includes a printed circuit board (PCB). For instance, in some embodiments, the circuit includes one or more flexible printed circuits (FPCs). By utilizing the FPC with the circuit, the electronic device 100 of the present disclosure is provided with improved durability since substantially all of the electronic device 100 is formed of or on a deformable material. For instance, in some embodiments, a circuit component 200 of a circuit of the optical device 100 includes a terminal, an energy source (e.g., power supply 176 of FIG. 1 or battery 500 of FIGS. 5-20), an interconnect (e.g., a line interconnect, such as a wire), a load (e.g., a device such as display 182 of FIG. 1, a light source 504, etc.), a controller (e.g., switch, CPU 174 of FIG. 1), or a combination thereof. As a non-limiting example, in some embodiments, the circuit component 200 includes a terminal, a resistor, a transistor, a capacitor, an inductor, a transformer, a diode, a sensor, a light source or combination thereof. In some embodiments, the first circuit component 200-1 is the same type of component as the second circuit component 200-1 (e.g., both the first circuit component 200-1 and the second circuit component 200-2 include a light source, both the first circuit component 200-1 and the second circuit component 200-2 include a light source configured to emit light from the visible spectrum, etc.). However, the present disclosure is not limited thereto.

In some embodiments, the first circuit component 200-1 and the second circuit component 200-2 are part of a transistor switch. For instance, in some embodiments, the transistor switch is configured to control an electronical communication through the optical device 100 using a logic function, such as an OR logic function based on either a cutoff or saturation of the electronical communication. In some embodiments, two or more transistor switches are arranged (e.g., in series and/or parallel) in order to implement a logic function, such as one or more logic functions of FIG. 10. For instance, in some embodiments, a first state of the first circuit component 200-1 (e.g., an ON state, an OFF state, a first state associate with a first wavelength of light, a second state associated with a second wavelength of light, etc.) and/or a second state of the second circuit components 200-2 are used to display an interpretation or output of the logic functions of FIG. 10. However, the present disclosure is not limited thereto.

In some embodiments, the circuit components 200 are disposed at one or more specific positions of the optical device 100 relative to one another and relative to a specific reference point on the optical device. In some embodiments, the circuit components 200 is located beneath an exterior surface of the optical device, such as disposed interposing between two or more layers of the semi-transparent frame 102 of the optical device 100. Accordingly, the optical device 100 of the present disclosure is capable of incorporating a variety of numbers of circuit components 200, which allows providing optical devices 100 of high complexity, such as wearable garment optical devices 100, with substrates 502 that permit continuous electronic communication between two or more circuit components 200 of the optical device 100 when the optical device 100 is physically deformed, or the like.

In some embodiments, as shown in FIG. 2A, the optical device 100 includes display device 700 includes a frame 102 and one or more lens or displays 106, hereinafter “display.”

In some embodiments, the display 106 is a lens, such as a first lens including a glass material, a silicon material, a polymeric material, or a combination thereof, which allows for the wearer to use the optical device 100 as eyewear, such as prescription eyewear, during everyday activities. In some embodiments, the display 106 is configured for presenting visual contents (e.g., augmented reality contents, virtual reality contents, mixed reality contents, or any combination thereof) to a user, such as the wearer or an observer viewing the wearer.

In some embodiments, the display 106 of the optical device 100 is configured as an augmented reality (AR) headset. In some embodiments, the display 106 of the optical device 100 is configured to augment views of a physical, real-world environment with computer-generated elements (e.g., images, video, sound, etc.). Moreover, in some embodiments, the display 106 of the optical device 100 is configured is able to cycle between different types of operation. Thus, in some embodiments, the display 106 of the optical device 100 is configured operate as a mixed reality (MR) device capable of providing a fully virtual reality (VR) experience, an augmented reality (AR) device, as smart glasses or some combination thereof (e.g., glasses with no optical correction, glasses optically corrected for the user, sunglasses, or some combination thereof) based on instructions from application engine. In some embodiments, the device may not include a display and only include the light guide described herein.

FIG. 2B illustrates an example optical device (e.g., a pair of augmented-reality glasses) that illustrate example locations in which removable batteries can be placed, in accordance with some exemplary embodiments of the patent disclosure. FIG. 2B shows that the temple arms 104-1 and 104-2 include cavities 210A and 210B (occluded) that house removable batteries 212A and 212B. The batteries 212A (occluded) and 212B are enclosed within the cavities 210A and 210B by battery doors 214A and 214B, which can be either integrated with the batteries or separate from the batteries. While two batteries are shown, it is possible that additional removable batteries can be attached to the temple arms. Additional details of the batteries, battery doors, and other related concepts are described throughout this application.

Referring to FIGS. 3 and 4, in some embodiments, the pair of smart glasses includes a temple arm 104-1.

In some embodiments, the temple arm 104-1 includes a surface 300 configured to couple to another surface, such as a first temple cover 302. In some embodiments, the temple arm 104-1 is configured to have a removable temple tip area 304. In some embodiments, as shown in FIG. 4, the temple arm 104-1 is configured to have a layer of adhesive, such as a glue line 402 that is disposed around a first portion 404 of the temple arm 104-1, such as a portion of an interior surface of the temple arm. In some embodiments, the adhesive terminates at a second portion 406 of the interior surface, which allows for the temple arm to removably decouple at the second portion. In some embodiments, the temple arm 104-1 includes a gasket 408 disposed at the second portion, which allows for sealing the interior of the temple arm 104-1. In some embodiments, the temple arm 104-1 includes a groove or an opening 410, such as a first groove or opening formed at an end portion of the temple arm, which allows for a simple prying tool 412 (e.g. a guitar pick) to insert and open up the temple arm. However, the present disclosure is not limited thereto.

In some embodiments, a cover of the temple arm (e.g., the removable temple tip area 304) is destroyed when decoupling the cover from the temple arm, such as by materially defecting the gasket 408 that seals the interior of the temple arm. However, the present disclosure is not limited thereto.

In some embodiments, the temple arm 104-1 includes a battery (e.g., battery 212A, 212B), a cover (e.g., first temple cover 302 and/or removable temple tip area 304), and a seal (e.g., glue line 402 and/or gasket 408). In some embodiments, the battery is disposed within a cavity 414 of the temple arm 104-1. Moreover, in some embodiments, the cover encloses the battery located within the cavity 414 of the temple arm. Furthermore, in some embodiments, the seal at least partially secures the cover to the temple arm 104-1. In some embodiments, the seal is configured to prevent moisture and debris ingress into the cavity. Additionally, in some embodiments, the seal includes a section that is configured to facilitate removal of the cover from the temple arm for replacing the battery.

In some embodiments, the seal comprises an adhesive and a reusable gasket material. In some embodiments, the adhesive comprises a structural adhesive, a pressure-sensitive adhesive, and/or a thermally activated adhesive. In some embodiments, the reusable gasket material comprises silicone, thermoplastic elastomer (TPE), ethylene propylene diene monomer (EPDM), or fluoroelastomer.

In some embodiments, the seal comprises at least an adhesive disposed around a remaining section of a perimeter of the cover and at least a gasket at the section that facilitates removal of the cover. In some embodiments, the adhesive section is disposed around 60%, 70%, 80%, 90%, 95%, or 99% of the perimeter of the cover. In some embodiments, the gasket section comprises between 1% and 40% of the perimeter of the cover. In some embodiments, the gasket section is positioned at a corner, edge, or end portion of the cover. In some embodiments, multiple gasket sections are positioned at different locations around the perimeter of the cover.

In some embodiments, the section that facilitates removal of the cover does not comprise an adhesive. In some embodiments, the section that facilitates removal of the cover comprises only gasket material. In some embodiments, the section that facilitates removal of the cover comprises a mechanical fastener, such as a snap-fit connection, a threaded connection, or a bayonet connection. In some embodiments, the section that facilitates removal of the cover comprises a magnetic coupling.

In some embodiments, the seal is recessed within the temple arm at the section that is configured to facilitate removal of the cover such that a pry tool can be inserted into the section for aiding in removing the cover. In some embodiments, the recess has a depth of 0.5 mm to 3 mm. In some embodiments, the recess has a width of 2 mm to 10 mm. In some embodiments, the pry tool comprises a guitar pick, a thin blade, or a specialized removal tool. In some embodiments, the recess includes a chamfered or rounded edge to facilitate tool insertion.

In some embodiments, the seal is constructed of a gasket material at the section that is configured to facilitate removal of the cover to aid in removal of the cover. In some embodiments, the gasket material has a Shore A hardness between 30 and 80. In some embodiments, the gasket material is overmolded onto the cover or temple arm. In some embodiments, the gasket material is insert-molded during manufacturing of the cover or temple arm. In some embodiments, the gasket material comprises multiple durometer zones with varying hardness levels.

In some embodiments, the cover is configured to be removed and attached at least 1,000 times before moisture and debris prevention of the seal is comprised. In some embodiments, the cover is configured to be removed and attached at least 500, 750, 1,500, 2,000, or 5,000 times before seal performance is compromised. In some embodiments, the seal maintains an IP54, IP65, or IP67 rating throughout the specified number of removal and attachment cycles. In some embodiments, the gasket section is designed to maintain sealing performance while the adhesive section provides structural integrity.

In some embodiments, the battery is configured to be removed after the cover is removed, such that a replacement battery can be installed. In some embodiments, the battery includes retention features such as spring clips, tabs, or magnetic elements to secure the battery within the cavity. In some embodiments, the battery includes a pull tab or handle to facilitate removal. In some embodiments, the battery is keyed or shaped to prevent incorrect installation. In some embodiments, multiple batteries can be housed within the temple arm cavity.

In some embodiments, the cover partially secures to the temple arm via a clip. In some embodiments, the clip comprises a cantilever beam, a torsional spring, or a living hinge. In some embodiments, multiple clips are positioned around the perimeter of the cover. In some embodiments, the clip is integrated into the cover or temple arm structure. In some embodiments, the clip provides both mechanical retention and electrical grounding. In some embodiments, the clip is designed to provide tactile feedback when the cover is properly seated.

In some embodiments, the cover comprises at least two pieces. In some embodiments, the cover comprises a primary cover and a secondary cover, wherein the secondary cover provides access to specific components while the primary cover remains in place. In some embodiments, the two pieces are connected via a hinge, sliding mechanism, or removable fastener. In some embodiments, each piece of the cover has its own sealing system. In some embodiments, the multiple pieces allow for staged access to different internal components.

In some embodiments, the temple arm includes another battery. In some embodiments, the temple arm includes two, three, or more batteries arranged in series or parallel configuration. In some embodiments, each battery has its own dedicated cover and sealing system. In some embodiments, the multiple batteries are accessed through a single cover. In some embodiments, the batteries have different capacities, chemistries, or form factors. In some embodiments, the batteries are hot-swappable, allowing replacement of one battery while others remain operational.

In some embodiments, an indication is located on the cover indicating where to initiate removal of the battery. In some embodiments, the indication comprises a visual marking, tactile feature, or color coding. In some embodiments, the indication comprises an arrow, symbol, text, or geometric pattern. In some embodiments, the indication is molded, printed, etched, or laser-marked onto the cover surface. In some embodiments, the indication includes step-by-step instructions for battery removal. In some embodiments, the indication is illuminated or includes phosphorescent material for visibility in low-light conditions.

In some embodiments, the temple arm is configured to receive a tool at the section that is configured to facilitate removal of the cover for reducing damage to the temple arm and/or cover upon removal of the cover from the temple arm. In some embodiments, the temple arm includes tool guides, channels, or stops to control tool placement and movement. In some embodiments, the temple arm includes reinforced areas adjacent to the tool insertion points to prevent structural damage. In some embodiments, the temple arm includes visual or tactile indicators showing proper tool positioning. In some embodiments, the temple arm is designed to accommodate multiple tool types or sizes. In some embodiments, the temple arm includes protective features to prevent over-insertion or misalignment of removal tools.

In some embodiments, a pair of augmented-reality glasses includes one or more temple arms. In some embodiments, the temple arm includes a battery located within a cavity of the temple arm. In some embodiments, the temple arm further includes a cover that encloses the battery located within the cavity of the temple arm. In some embodiments, the temple arm includes a seal that at least partially secures the cover to the temple arm. In some embodiments, the seal is configured to prevent moisture and debris ingress into the cavity, and includes a section that is configured to facilitate removal of the cover from the temple arm for replacing the battery.

Referring to FIGS. 5-7, in some embodiments, the present disclosure is directed to providing systems, devices, and methods for replacing a battery.

In some embodiments, the present disclosure provides a tab 502 disposed on a surface of a battery 500, such that the tab 502 is attached to the battery 500. In some embodiments, the tab 502 is coupled to the battery 500 without adhesive. For example, the tap 502 is coupled to the battery 500 by wrapping around the battery 500. In some embodiments, the battery 500 includes one or more spring clips 504 configured to engage and/or disengage the battery 500 from the device, such as disengaging the battery 500 from the device when the one or more spring clips 504 is compressed from an initial state, which allows for pull the battery 500 from the device using the tab 502. In some embodiments, the tab 502 removes the need for tools for battery removal. In some embodiments, the tab 502 does not require the user to place the tab 502 properly to allow disengagement, and reduces risk of removal issues or tool damage from removal. In some embodiments, the tab 502 includes one or more geometric structures that cause the tab 502 to be in the correct position and/or configuration to be inserted into a cavity for the battery 500. In some embodiments, the tab 502 is configured as a handle for the battery 500, which allow for carrying the battery 500 once removed from the device. In some embodiments, the battery 500 includes a layer of material, such as an adhesive backed material (e.g., PET, Kapton, and/or Vectran) and attaching the adhesive backed material to the battery 500 in a way that allows compression of the one or more spring clips 504 on the battery 500. For example, the tab 502 does not interfere with the one or more spring clips 504.

In some embodiments, a method of replacing a battery 500 in a temple arm 104-1 of a pair of smart glasses. In some embodiments, the method includes pulling a tab 502, wherein the tab 502 is a free end of a tape connected to the battery 500. In some embodiments, the method further includes compressing a spring clip 504 with the tab 502 as the tab 502 is pulled, disengaging the battery 500 from a cavity in the temple arm. In some embodiments, the tab 502 selectively engages with the spring clip 504 in response to pulling of the tab 502. In some embodiments, the method includes removing the battery 500 from the cavity by continuing to pull on the tab 502. In some embodiments, the method includes inserting a new battery, the new battery comprising a new tab connected to the new battery.

Referring to FIG. 20, in some embodiments, the present disclosure is directed to providing a temple arm 104-1 of a pair of smart glasses. In some embodiments, the temple arm 104-1 includes a battery 500 located within a cavity 210A of a temple arm 104-1. In some embodiments, the temple arm 104-1 includes a plurality of charging contacts 2000 within the cavity 210A, in which the battery 500 is configured to contact the plurality of charging contacts 2000 to provide power to the pair of smart glasses. In some embodiments, the battery 500, includes contacts 2002 on a circuit board 2004 of the battery 500. The contacts 2002 are configured to couple with the charging contacts 2000 of the temple arm 104-1. In some embodiments, the temple arm 104-1 includes a battery door located on the temple arm that encloses the battery within the cavity of the temple arm. In some embodiments, the battery door operates between (i) an open state in which the battery door does not apply sufficient force to the battery for securing the plurality of charging contacts to the battery, and (ii) a closed state in which the battery door applies sufficient force to the battery for securing the plurality of charging contacts to the battery.

In some embodiments, the charging contacts 2000 are spring loaded, such that the battery 500 is ejected from the cavity 210A of the temple arm when the battery door is removed.

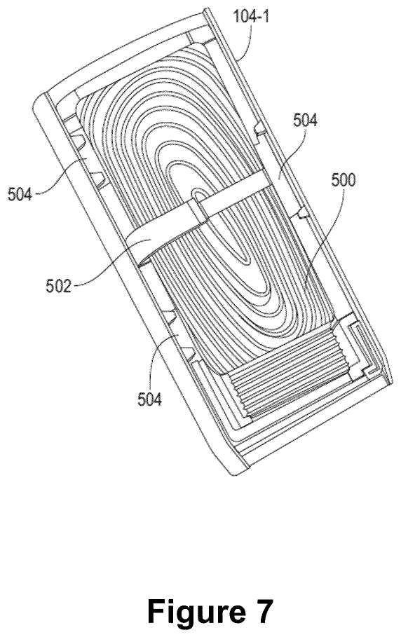

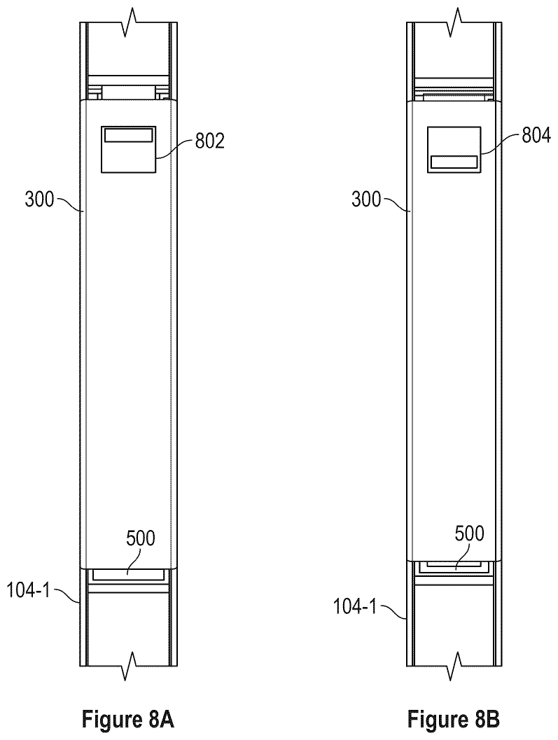

Referring to FIGS. 8-19, in some embodiments, the present disclosure is directed to providing a temple arm of a pair of smart glasses. In some embodiments, the temple arm includes a cavity cut into the temple arm. In some embodiments, the temple arm includes a battery removably housed within the cavity. In some embodiments, the temple arm includes a removable door configured to cover an opening of the cavity, the door having a release latch. In some embodiments, the latch includes a slidable portion, and a flat spring connected to the slidable portion, in which the flat spring is compressed when the slidable portion is moved. In some embodiments, the latch further includes a protrusion that interacts with the temple arm and is connected to the flat spring such that when the flat spring is compressed, the protrusion moves relative to the temple arm to release the latch.

In some embodiments, the slidable portion of the latch is configured to be operated by a finger. In some embodiments, the slidable portion includes a textured surface, raised ridges, and/or ergonomic contours to facilitate finger operation. In some embodiments, the slidable portion has a width of 3 mm to 8 mm to accommodate finger operation. In some embodiments, the slidable portion requires a force of 2 N to 10 N to actuate. In some embodiments, the slidable portion includes tactile feedback features such as detents or clicks to indicate proper operation.

In some embodiments, the slidable portion of the latch is configured to be operated by a specialized tool. In some embodiments, the specialized tool comprises a plastic spudger, a small screwdriver, a guitar pick, or a custom-designed actuator tool. In some embodiments, the slidable portion includes a tool engagement feature such as a slot, recess, or shaped opening designed to receive the specialized tool. In some embodiments, the tool engagement feature has a specific geometric shape to prevent operation with incorrect tools. In some embodiments, the specialized tool is provided with the smart glasses or available separately. In some embodiments, the tool engagement feature includes anti-slip features to prevent the tool from slipping during operation. In some embodiments, the specialized tool includes a magnetic tip or retention feature to prevent loss during battery replacement procedures.

In some embodiments, the present disclosure is directed to a method of using a battery and/or a temple arm of an optical device configured in accordance with any of an embodiment of the present disclosure. In some embodiments, the method includes removing a cover from a temple arm by inserting a pry tool at a gasket section and applying leverage to separate the cover from the temple arm. In some embodiments, the method includes removing a battery from a cavity by pulling a tab connected to the battery until spring clips are compressed and the battery disengages from the cavity. In some embodiments, the method includes installing a replacement battery by aligning the battery with slots in the cavity and pressing until spring clips engage with the slots. In some embodiments, the method includes reattaching the cover by aligning notches of the cover with slots in the temple arm and pressing until the gasket section forms a seal. In some embodiments, the method includes verifying proper installation by checking that charging contacts are properly seated and the cover is flush with the temple arm. In some embodiments, the method includes testing electrical connectivity after battery replacement to ensure proper operation of the smart glasses.

Referring to FIG. 3, a partially exploded view of a pair of smart classes is provided, in which a temple arm includes a cover removable coupled from the temple arm and a seal is a gasket that is formed over molded to an interior surface of the cover. However, the present disclosure is not limited thereto.

Referring to FIG. 4, a view of an interior surface of a temple arm is provided, in which the interior surface include a seal including an adhesive layer (e.g., glue line) and/or a gasket, which allows for removing a cover from the temple arm, such as by using a tip of a prying tool (e.g., a guitar pick). However, the present disclosure is not limited thereto.

Referring to FIGS. 5-7, a battery includes a tab fixedly coupled to a surface of the battery, which allows for disposing and/or removing the battery from an interior of a temple arm without having to manipulate a location of the tab and carry the battery to and/or from the temple arm using the tab. However, the present disclosure is not limited thereto.

Referring to FIG. 8A, a battery 500 and/or battery cover 300 includes an actuator in a locked position 802 and FIG. 8B shows actuator in an unlocked position 804, in which an actuator of the battery 500 is traversed from an upper end portion of an aperture of the battery 500 to a lower end portion of the aperture. However, the present disclosure is not limited thereto.

Referring to FIGS. 9-12, in some embodiments, a battery 500 of the present disclosure is removed from a temple arm 104-1 by pushing the actuator of the battery 500 from a first position (e.g., actuator in a locked position 802) to a second position (e.g., actuator in an unlocked position 804, which allows for rotating a cover of the battery that includes the actuator away from the battery 500, thereby allow for removal of the cover from the temple arm and the battery from an interior of the temple arm, such as using one or more tabs 502 and/or springs protruding from a surface of the battery. However, the present disclosure is not limited thereto.

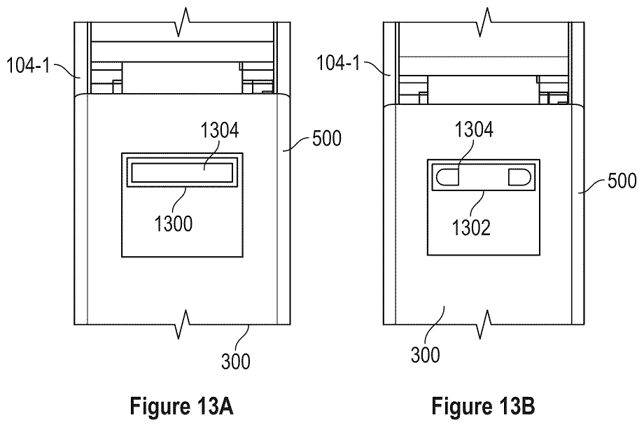

Referring to FIGS. 13A-13B, in some embodiments, the actuator 1300, 1302 of the battery includes one or more openings 1304, 1306, which allows for controlling the actuator using one or more corresponding mating structure received by each opening in the one or more openings. In some embodiments, the opening 1304 of the actuator 1300 is configured to be actuated by a finger of a user. The opening 1304 of the actuator 1300 may be configured to be actuated by a tool with a shape corresponding to the opening 1304 (e.g., a tool with a flat rectangular shape). In some embodiments, the opening 1306 of the actuator 1302 is configured to require a tool with a shape corresponding to the opening 1306 (e.g., a tool with two prongs that are a partially rounded rectangular shape). However, the present disclosure is not limited thereto.

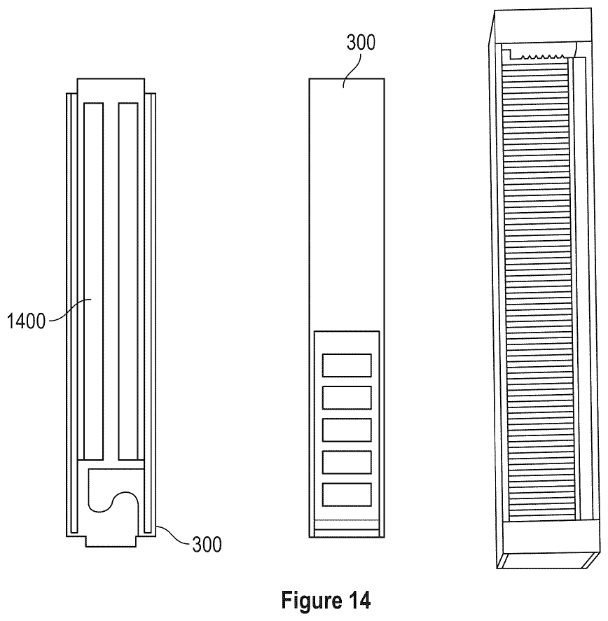

Referring to FIGS. 14-16, in some embodiments, the cover 300 of the battery 500 includes a deformable substrate or material, such as a foam layer, which allows for interfacing the deformable substrate 1400 or material against a surface of the battery when coupled to the temple arm, which if a thickness of the deformable substrate or material is greater than a gap between the surface of the battery and a surface of the temple arm. In some embodiments, the deformable substrate 1400 or material maintains a position of a battery relative to the contacts of the temple arm so that the battery can continue to provide power to the smart glasses. In some embodiments, the deformable substrate 1400 or material dampens forces to the battery 500 (e.g., provides protection to the battery 500 during a drop event). However, the present disclosure is not limited thereto.

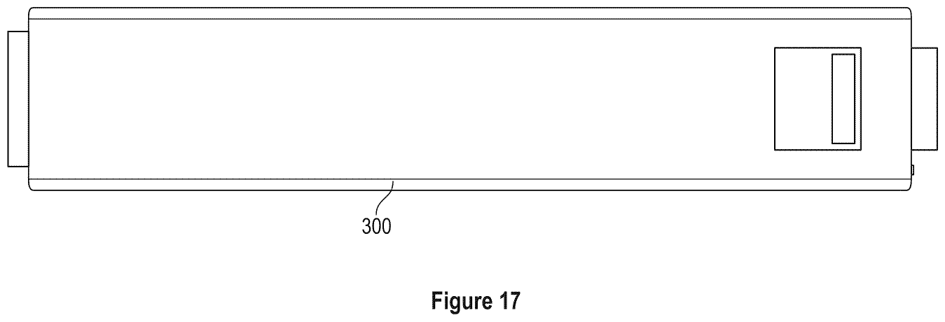

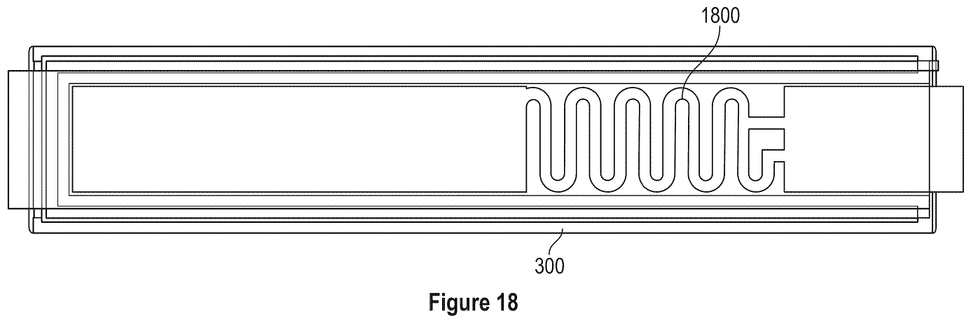

Referring to FIGS. 17-18, in some embodiments, the actuator includes a spring structure 1800, such as a monolithic spring structure, which allows for biasing the actuator in a first position, such as a locked position. However, the present disclosure is not limited thereto.

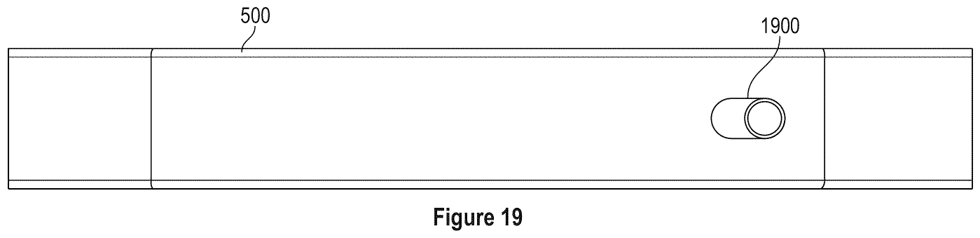

Referring to FIG. 19, in some embodiments, the actuator includes a protrusion 1900 having the one or more openings, in which each opening in the one or more openings is configured to accommodate a corresponding mating structure. However, the present disclosure is not limited thereto.

Referring to FIG. 20, in some embodiments, the temple arm includes one or more electrodes, such as one or more electronical contacts, configured to electronically couple a battery and a processor of the temple arm. However, the present disclosure is not limited thereto.

FIG. 21A illustrates a temple arm 2100 on a pair of smart glasses 2102 that are configured to receive a removable battery 2104, in accordance with some embodiments. FIG. 21A shows a cutaway view 2106 of the temple arm 2100, that includes a cutout 2108 for receiving the removable battery 2104. The cutout 2108 is sealed off by a removable cover 2110 that can include a moisture and debris seal to stop ingress of moisture and debris.

The cutout includes slots 2112A and 2112B on each side and in some embodiments alignment features, that hold both the battery 2104 and the removable cover in place. By using the same slots 2112A and 2112B to secure both the battery 2104 and the removable cover 2110, the internal space of cut out is maximized which can allow for a larger battery to be used or make space for other components within the temple arm.

The battery 2104 includes one or more spring clips for securing the battery 2104 within the cutout 2108. For example, battery 2108 shows two spring clips 2114A and 2114B on one side 2116 of the battery 2108, and while occluded an additional spring clip 2114C is secured to the other side 2118 of the battery 2108. In some embodiments, these spring clips 2114A-2114C can be welded (e.g., laser welded) to the exterior of the battery 2108 (e.g., a metal can battery). The spring clips are configured to secure in place along the slots 2112A and 2112B.

The removable cover 2110 also includes notches 2111A and 2111B that are configured to interface with the slot 2112A, but in different locations than the where the spring clips 2114A-2114B of the battery 2108 interface with slot 2112A. As shows the cover 2110 includes regions 2120A and 2120B on a first side 2122 with no notches to accommodate spring clips 2114A and 2114B. Similarly, notches 2111C and 2111D can also be included on a second side 2124 (e.g., an adjacent or opposite side) that secure to slot 2112B. While these are occluded in the figure, the one or more notches would be placed in locations different than spring clip 2114C. In some embodiments, the removable cover is configured to be removed (e.g., at least 20 times) without compromising ingress protection. In some embodiments, the notches are configured to flex such that the cover can be removed by the user.

Alternatively, slots can be placed on the removable cover 2110 and/or battery 2108, which can interface with notches and spring clips, respectively, located within the cutout 2108.

FIG. 21B illustrates that both of the spring clip 2114A of the battery 2108 and the notches 2111A and 2111B of the removable cover 2110 are both interfacing with the slot 2112A, in accordance with some embodiments. As illustrated, the notches 2111A and 2111B and spring clip 2114A are all along the same axis as a result of them all interfacing with the slot 2112A.

As described previously, to have batteries be user replaceable, the battery should have an electrical mating solution to the system which is not permanent and should have mechanical features to enable easy removal and installation. This becomes more difficult when reducing the size of the battery and system. Use of B2B connectors for smart glasses is not preferred for replaceability due to the size of the B2Bs and likelihood of damage during battery replacement. Alternative connection methods such as pogo pins, spring contacts, or flexible circuit boards may be used but each presents unique challenges in terms of durability, reliability and space constraints.

Any spring contact and mating electrical pads should fit within the space devoted to battery width. For glasses products, this is often ˜10 mm, though widths between 8-15 mm may be suitable depending on the specific design requirements. Within this width, a battery connection system may require 5-6 mating pins between the battery and system, though some embodiments may use 3-8 pins depending on power and control requirements. The alignment tolerance between the battery and system contacts must be controlled such that pad to pad shorting is avoided, typically requiring alignment precision of 0.1-0.3 mm. The main two problems to solve can be distilled to (1) tightly controlled alignment tolerance between the battery pads and the system spring fingers, and (2) Lack of space for all features, e.g., 5-6 contacts, cell to logic board connection and alignment features. Additional challenges include maintaining reliable contact pressure, preventing oxidation or contamination of contact surfaces, and ensuring consistent performance over multiple insertion/removal cycles.

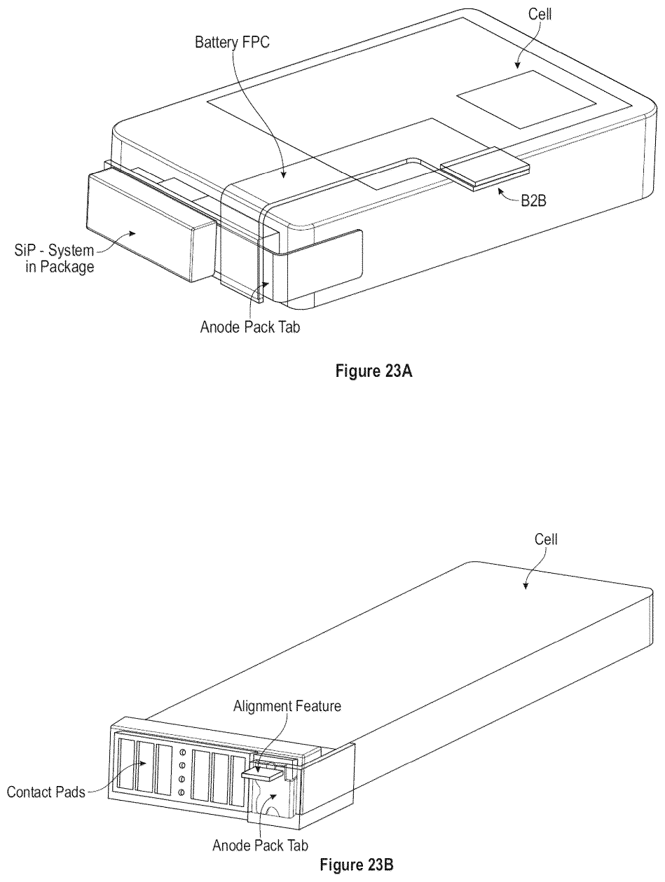

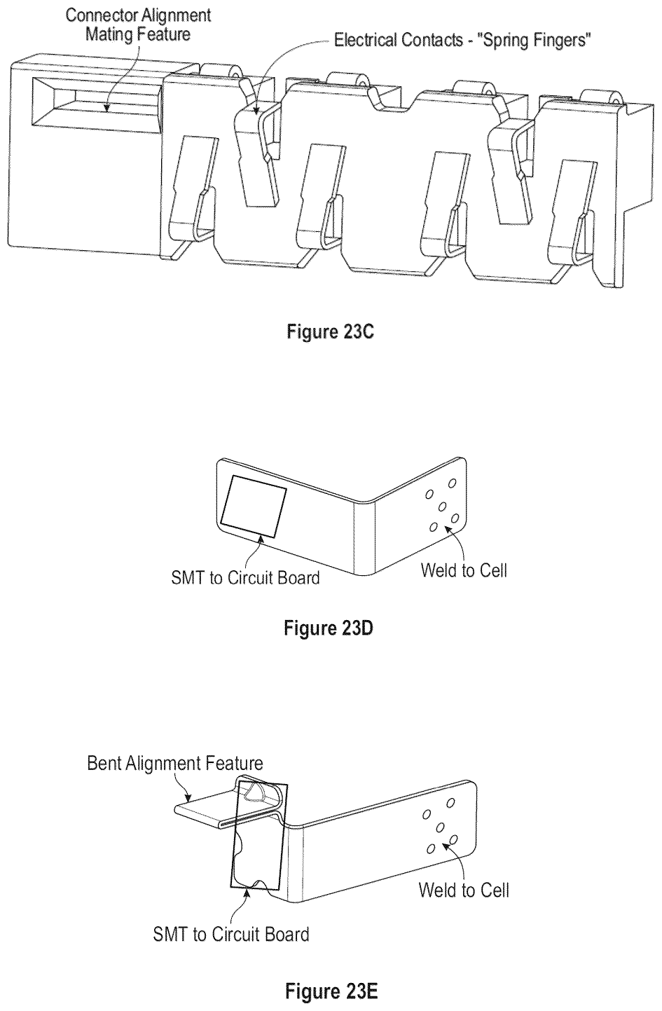

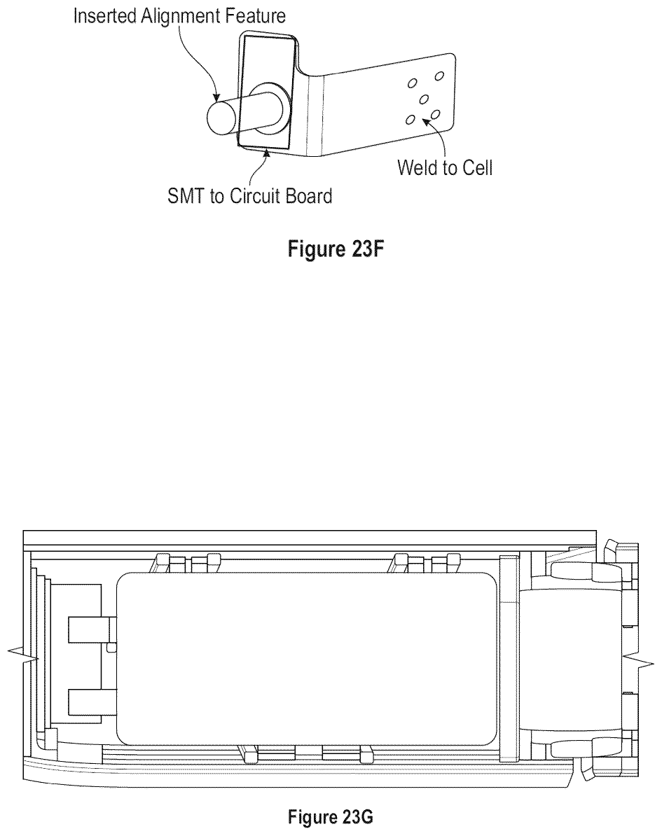

A tight tolerance loop between the battery contact pads and the system side connector may be necessary. As disclosed herein, to accomplish this an alignment feature may be added on the battery PCM co-located with the battery pads which mates with the housing for the system spring fingers (e.g., as illustrated in FIGS. 23B and 23C). The alignment feature may comprise various geometries including cylindrical posts, rectangular keys, dovetail joints, or tapered guide pins. The alignment features may be positioned symmetrically or asymmetrically to prevent incorrect insertion.

Another solution disclosed herein is to package battery to system alignment and cell to PCM electrical connection to a single part or single sub-assembly. FIG. 23D illustrates an example cell anode to PCM connection component. In this example, one end is SMTd to the PCM using lead-free solder, conductive adhesive, or other suitable bonding methods. The other end is welded to the steel can of the cell which is the cell anode, using techniques such as resistance welding, laser welding, or ultrasonic welding. This component may be referred to as an anode pack tab. The anode pack tab may be constructed from materials including copper, brass, nickel-plated steel, or other conductive metals with suitable mechanical properties.

An anode pack tab may serve as the electrical connection between the cell and the PCM and may have a mechanical mating feature to the system connector. FIG. 23E illustrates how the anode pack tab can be configured to include an alignment feature without additional parts to the assembly. This may be accomplished through hem and gusset sheet metal features to provide stiffness. The hem features may be single or double hemmed edges with widths between 0.2-1.0 mm. Gusset features may include triangular, rectangular or curved reinforcement structures.

FIG. 23F shows another configuration to accomplish a similar outcome by adding a pin insert pressed into the sheet metal anode pack tab. The pin insert may be made from hardened steel, brass, or other durable materials and may have knurled, splined, or textured surfaces to enhance retention in the sheet metal. Pin diameters may range from 0.5-2.0 mm depending on alignment requirements.

FIG. 23G illustrates an example battery retention system in accordance with some embodiments. FIG. 23G shows a top-down view of a battery retention system having two spring clips on top (and optionally one on the bottom) for battery retention. For example, the spring clips may be made from stainless steel, phosphor bronze, or beryllium copper with thicknesses between 0.1-0.3 mm. In some embodiments, the battery uses spring clips welded directly to the can of the battery for retention. In some embodiments, a battery cover uses plastic snaps to retain the battery, which may be molded from materials such as polycarbonate, nylon, or PPS. The temple arm housing may have one cut out on each side and some alignment features that holds the battery in place. The cutouts may include chamfered or radiused edges to facilitate insertion. In some embodiments, the cover snaps are configured to go around the battery snaps. This means that the battery and cover retention features take up the same general space. Using a shared space for the battery and cover retention features provides additional space for either the battery or cover retention (e.g., allowing for a larger battery to be inserted and retained). The shared retention features may provide space savings of 10-30% compared to separate retention systems. FIG. 21B, described previously, provides a side view of the example battery described above, which illustrates how the cover snaps into a same interface as the battery snaps.

Some embodiments include a pair of glasses having at least one temple arm. The glasses include a battery disposed within a cavity of the temple arm, a cover that encloses the battery located within the cavity of the temple arm, and a seal that at least partially secures the cover to the temple arm and is configured to prevent moisture and debris ingress into the cavity. The seal includes an adhesive section that couples the cover and the temple arm, and a reusable gasket section removably coupled to the cover and the temple arm, where the gasket section is configured to facilitate removal of the cover from the temple arm for replacing the battery.

The example glasses address the challenge of enabling battery serviceability in compact electronic devices while maintaining device integrity and performance. A temple arm structure may include a battery disposed within a cavity, which may be a removable battery such as batteries 212A and 212B shown housed within cavities 210A and 210B of temple arms 104-1 and 104-2. The battery may be configured with spring clips 2114A, 2114B, and 2114C that secure the battery within the cutout. The cover that encloses the battery may be a removable cover 2110 that includes notches 2111A, 2111B, 2111C, and 2111D configured to interface with slots in the temple arm cavity. Such a hybrid sealing system represents a significant technical advancement, combining an adhesive section that provides strong structural bonding around most of the cover perimeter with a reusable gasket section that enables controlled access for battery replacement. This configuration allows the cover to maintain moisture and debris protection while facilitating user access, addressing the competing demands of serviceability, durability, and space optimization in compact electronic devices.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

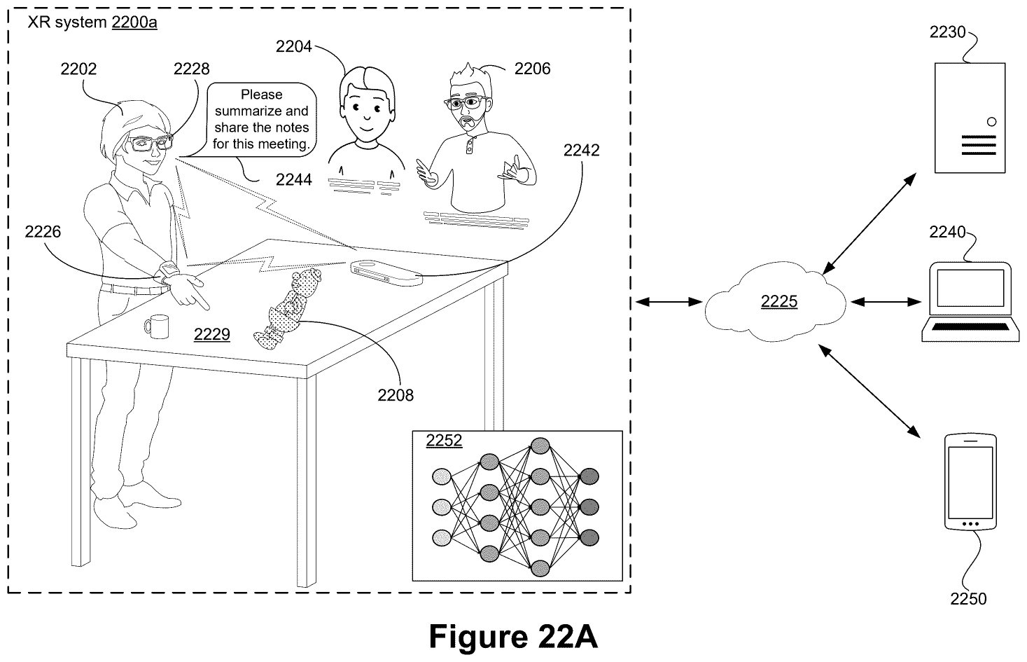

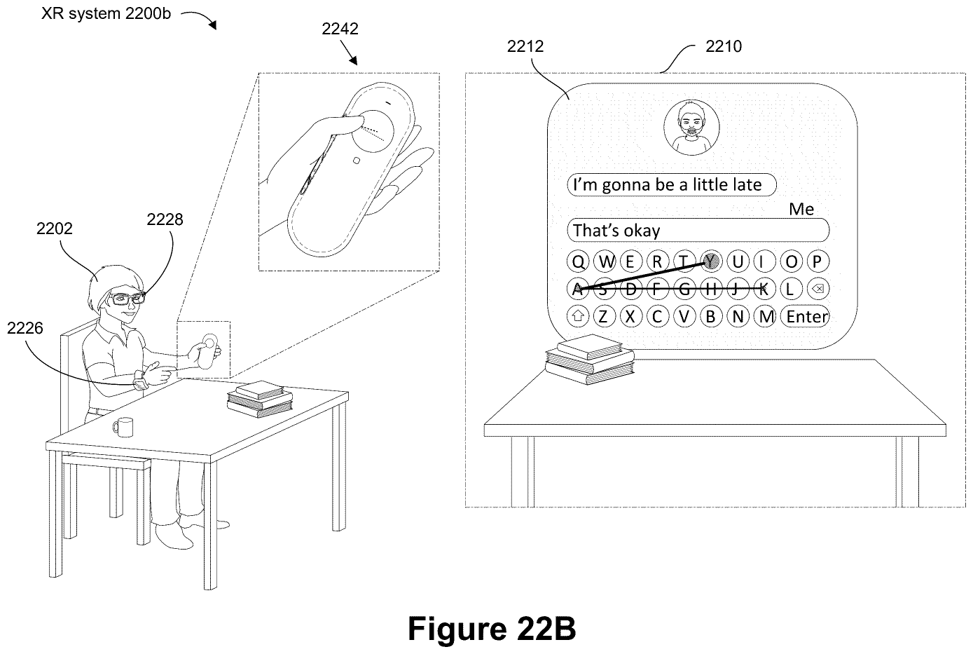

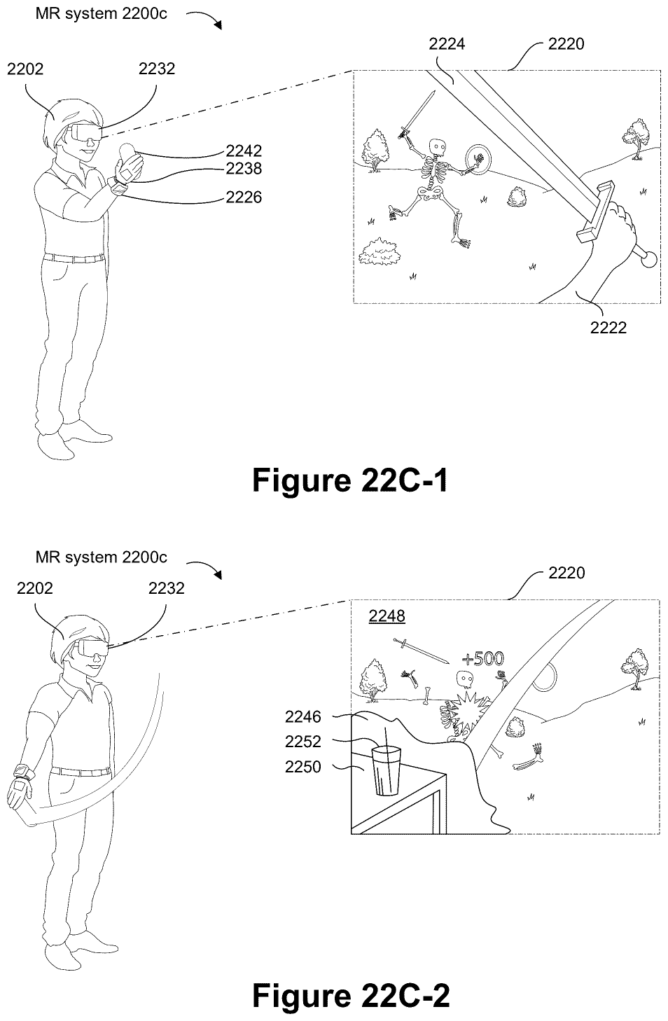

FIG. 22A 22B, 22C-1, and 22C-2, illustrate example XR systems that include AR and MR systems, in accordance with some embodiments. FIG. 22A shows a first XR system 2200a and first example user interactions using a wrist-wearable device 2226, a head-wearable device (e.g., AR device 2228), and/or a HIPD 2242. FIG. 22B shows a second XR system 2200b and second example user interactions using a wrist-wearable device 2226, AR device 2228, and/or an HIPD 2242. FIGS. 22C-1 and 22C-2 show a third MR system 2200c and third example user interactions using a wrist-wearable device 2226, a head-wearable device (e.g., an MR device such as a VR device), and/or an HIPD 2242. As the skilled artisan will appreciate upon reading the descriptions provided herein, the above-example AR and MR systems (described in detail below) can perform various functions and/or operations.

The wrist-wearable device 2226, the head-wearable devices, and/or the HIPD 2242 can communicatively couple via a network 2225 (e.g., cellular, near field, Wi-Fi, personal area network, wireless LAN). Additionally, the wrist-wearable device 2226, the head-wearable device, and/or the HIPD 2242 can also communicatively couple with one or more servers 2230, computers 2240 (e.g., laptops, computers), mobile devices 2250 (e.g., smartphones, tablets), and/or other electronic devices via the network 2225 (e.g., cellular, near field, Wi-Fi, personal area network, wireless LAN). Similarly, a smart textile-based garment, when used, can also communicatively couple with the wrist-wearable device 2226, the head-wearable device(s), the HIPD 2242, the one or more servers 2230, the computers 2240, the mobile devices 2250, and/or other electronic devices via the network 2225 to provide inputs.

Turning to FIG. 22A, a user 2202 is shown wearing the wrist-wearable device 2226 and the AR device 2228 and having the HIPD 2242 on their desk. The wrist-wearable device 2226, the AR device 2228, and the HIPD 2242 facilitate user interaction with an AR environment. In particular, as shown by the first AR system 2200a, the wrist-wearable device 2226, the AR device 2228, and/or the HIPD 2242 cause presentation of one or more avatars 2204, digital representations of contacts 2206, and virtual objects 2208. As discussed below, the user 2202 can interact with the one or more avatars 2204, digital representations of the contacts 2206, and virtual objects 2208 via the wrist-wearable device 2226, the AR device 2228, and/or the HIPD 2242. In addition, the user 2202 is also able to directly view physical objects in the environment, such as a physical table 2229, through transparent lens(es) and waveguide(s) of the AR device 2228. Alternatively, an MR device could be used in place of the AR device 2228 and a similar user experience can take place, but the user would not be directly viewing physical objects in the environment, such as table 2229, and would instead be presented with a virtual reconstruction of the table 2229 produced from one or more sensors of the MR device (e.g., an outward facing camera capable of recording the surrounding environment).

The user 2202 can use any of the wrist-wearable device 2226, the AR device 2228 (e.g., through physical inputs at the AR device and/or built-in motion tracking of a user's extremities), a smart-textile garment, externally mounted extremity tracking device, the HIPD 2242 to provide user inputs, etc. For example, the user 2202 can perform one or more hand gestures that are detected by the wrist-wearable device 2226 (e.g., using one or more EMG sensors and/or IMUs built into the wrist-wearable device) and/or AR device 2228 (e.g., using one or more image sensors or cameras) to provide a user input. Alternatively, or additionally, the user 2202 can provide a user input via one or more touch surfaces of the wrist-wearable device 2226, the AR device 2228, and/or the HIPD 2242, and/or voice commands captured by a microphone of the wrist-wearable device 2226, the AR device 2228, and/or the HIPD 2242. The wrist-wearable device 2226, the AR device 2228, and/or the HIPD 2242 include an artificially intelligent digital assistant to help the user in providing a user input (e.g., completing a sequence of operations, suggesting different operations or commands, providing reminders, confirming a command). For example, the digital assistant can be invoked through an input occurring at the AR device 2228 (e.g., via an input at a temple arm of the AR device 2228). In some embodiments, the user 2202 can provide a user input via one or more facial gestures and/or facial expressions. For example, cameras of the wrist-wearable device 2226, the AR device 2228, and/or the HIPD 2242 can track the user 2202's eyes for navigating a user interface.

The wrist-wearable device 2226, the AR device 2228, and/or the HIPD 2242 can operate alone or in conjunction to allow the user 2202 to interact with the AR environment. In some embodiments, the HIPD 2242 is configured to operate as a central hub or control center for the wrist-wearable device 2226, the AR device 2228, and/or another communicatively coupled device. For example, the user 2202 can provide an input to interact with the AR environment at any of the wrist-wearable device 2226, the AR device 2228, and/or the HIPD 2242, and the HIPD 2242 can identify one or more back-end and front-end tasks to cause the performance of the requested interaction and distribute instructions to cause the performance of the one or more back-end and front-end tasks at the wrist-wearable device 2226, the AR device 2228, and/or the HIPD 2242. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 2242 can perform the back-end tasks and provide the wrist-wearable device 2226 and/or the AR device 2228 operational data corresponding to the performed back-end tasks such that the wrist-wearable device 2226 and/or the AR device 2228 can perform the front-end tasks. In this way, the HIPD 2242, which has more computational resources and greater thermal headroom than the wrist-wearable device 2226 and/or the AR device 2228, performs computationally intensive tasks and reduces the computer resource utilization and/or power usage of the wrist-wearable device 2226 and/or the AR device 2228.

In the example shown by the first AR system 2200a, the HIPD 2242 identifies one or more back-end tasks and front-end tasks associated with a user request to initiate an AR video call with one or more other users (represented by the avatar 2204 and the digital representation of the contact 2206) and distributes instructions to cause the performance of the one or more back-end tasks and front-end tasks. In particular, the HIPD 2242 performs back-end tasks for processing and/or rendering image data (and other data) associated with the AR video call and provides operational data associated with the performed back-end tasks to the AR device 2228 such that the AR device 2228 performs front-end tasks for presenting the AR video call (e.g., presenting the avatar 2204 and the digital representation of the contact 2206).

In some embodiments, the HIPD 2242 can operate as a focal or anchor point for causing the presentation of information. This allows the user 2202 to be generally aware of where information is presented. For example, as shown in the first AR system 2200a, the avatar 2204 and the digital representation of the contact 2206 are presented above the HIPD 2242. In particular, the HIPD 2242 and the AR device 2228 operate in conjunction to determine a location for presenting the avatar 2204 and the digital representation of the contact 2206. In some embodiments, information can be presented within a predetermined distance from the HIPD 2242 (e.g., within five meters). For example, as shown in the first AR system 2200a, virtual object 2208 is presented on the desk some distance from the HIPD 2242. Similar to the above example, the HIPD 2242 and the AR device 2228 can operate in conjunction to determine a location for presenting the virtual object 2208. Alternatively, in some embodiments, presentation of information is not bound by the HIPD 2242. More specifically, the avatar 2204, the digital representation of the contact 2206, and the virtual object 2208 do not have to be presented within a predetermined distance of the HIPD 2242. While an AR device 2228 is described working with an HIPD, an MR headset can be interacted with in the same way as the AR device 2228.

User inputs provided at the wrist-wearable device 2226, the AR device 2228, and/or the HIPD 2242 are coordinated such that the user can use any device to initiate, continue, and/or complete an operation. For example, the user 2202 can provide a user input to the AR device 2228 to cause the AR device 2228 to present the virtual object 2208 and, while the virtual object 2208 is presented by the AR device 2228, the user 2202 can provide one or more hand gestures via the wrist-wearable device 2226 to interact and/or manipulate the virtual object 2208. While an AR device 2228 is described working with a wrist-wearable device 2226, an MR headset can be interacted with in the same way as the AR device 2228.

### Integration of Artificial Intelligence With XR Systems

FIG. 22A illustrates an interaction in which an artificially intelligent virtual assistant can assist in requests made by a user 2202. The AI virtual assistant can be used to complete open-ended requests made through natural language inputs by a user 2202. For example, in FIG. 22A the user 2202 makes an audible request 2244 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 22A also illustrates an example neural network 2252 used in Artificial Intelligence applications. Uses of Artificial Intelligence (AI) are varied and encompass many different aspects of the devices and systems described herein. AI capabilities cover a diverse range of applications and deepen interactions between the user 2202 and user devices (e.g., the AR device 2228, an MR device 2232, the HIPD 2242, the wrist-wearable device 2226). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 2202 can interact with an AI model through natural language inputs captured by a voice sensor, text inputs, or any other input modality that accepts natural language and/or a corresponding voice sensor module. In another instance, input is provided by tracking the eye gaze of a user 2202 via a gaze tracker module. Additionally, the AI model can also receive inputs beyond those supplied by a user 2202. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 2228) or from multiple devices that are in communication with each other (e.g., a system that includes at least two of an AR device 2228, an MR device 2232, the HIPD 2242, the wrist-wearable device 2226, etc.). The AI model can also access additional information (e.g., one or more servers 2230, the computers 2240, the mobile devices 2250, and/or other electronic devices) via a network 2225.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 2228, an MR device 2232, the HIPD 2242, the wrist-wearable device 2226) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 2228, an MR device 2232, the HIPD 2242, the wrist-wearable device 2226), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 2242), haptic feedback can provide information to the user 2202. An AI model can also use the inputs described above to determine the appropriate modality and device(s) to present content to the user (e.g., a user walking on a busy road can be presented with an audio output instead of a visual output to avoid distracting the user 2202).

### Example Augmented Reality Interaction

FIG. 22B shows the user 2202 wearing the wrist-wearable device 2226 and the AR device 2228 and holding the HIPD 2242. In the second AR system 2200b, the wrist-wearable device 2226, the AR device 2228, and/or the HIPD 2242 are used to receive and/or provide one or more messages to a contact of the user 2202. In particular, the wrist-wearable device 2226, the AR device 2228, and/or the HIPD 2242 detect and coordinate one or more user inputs to initiate a messaging application and prepare a response to a received message via the messaging application.

In some embodiments, the user 2202 initiates, via a user input, an application on the wrist-wearable device 2226, the AR device 2228, and/or the HIPD 2242 that causes the application to initiate on at least one device. For example, in the second AR system 2200b the user 2202 performs a hand gesture associated with a command for initiating a messaging application (represented by messaging user interface 2212); the wrist-wearable device 2226 detects the hand gesture; and, based on a determination that the user 2202 is wearing the AR device 2228, causes the AR device 2228 to present a messaging user interface 2212 of the messaging application. The AR device 2228 can present the messaging user interface 2212 to the user 2202 via its display (e.g., as shown by user 2202's field of view 2210). In some embodiments, the application is initiated and can be run on the device (e.g., the wrist-wearable device 2226, the AR device 2228, and/or the HIPD 2242) that detects the user input to initiate the application, and the device provides another device operational data to cause the presentation of the messaging application. For example, the wrist-wearable device 2226 can detect the user input to initiate a messaging application, initiate and run the messaging application, and provide operational data to the AR device 2228 and/or the HIPD 2242 to cause presentation of the messaging application. Alternatively, the application can be initiated and run at a device other than the device that detected the user input. For example, the wrist-wearable device 2226 can detect the hand gesture associated with initiating the messaging application and cause the HIPD 2242 to run the messaging application and coordinate the presentation of the messaging application.

Further, the user 2202 can provide a user input provided at the wrist-wearable device 2226, the AR device 2228, and/or the HIPD 2242 to continue and/or complete an operation initiated at another device. For example, after initiating the messaging application via the wrist-wearable device 2226 and while the AR device 2228 presents the messaging user interface 2212, the user 2202 can provide an input at the HIPD 2242 to prepare a response (e.g., shown by the swipe gesture performed on the HIPD 2242). The user 2202's gestures performed on the HIPD 2242 can be provided and/or displayed on another device. For example, the user 2202's swipe gestures performed on the HIPD 2242 are displayed on a virtual keyboard of the messaging user interface 2212 displayed by the AR device 2228.

In some embodiments, the wrist-wearable device 2226, the AR device 2228, the HIPD 2242, and/or other communicatively coupled devices can present one or more notifications to the user 2202. The notification can be an indication of a new message, an incoming call, an application update, a status update, etc. The user 2202 can select the notification via the wrist-wearable device 2226, the AR device 2228, or the HIPD 2242 and cause presentation of an application or operation associated with the notification on at least one device. For example, the user 2202 can receive a notification that a message was received at the wrist-wearable device 2226, the AR device 2228, the HIPD 2242, and/or other communicatively coupled device and provide a user input at the wrist-wearable device 2226, the AR device 2228, and/or the HIPD 2242 to review the notification, and the device detecting the user input can cause an application associated with the notification to be initiated and/or presented at the wrist-wearable device 2226, the AR device 2228, and/or the HIPD 2242.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 2228 can present to the user 2202 game application data and the HIPD 2242 can use a controller to provide inputs to the game. Similarly, the user 2202 can use the wrist-wearable device 2226 to initiate a camera of the AR device 2228, and the user can use the wrist-wearable device 2226, the AR device 2228, and/or the HIPD 2242 to manipulate the image capture (e.g., zoom in or out, apply filters) and capture image data.

While an AR device 2228 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 22C-1 and 22C-2, the user 2202 is shown wearing the wrist-wearable device 2226 and an MR device 2232 (e.g., a device capable of providing either an entirely VR experience or an MR experience that displays object(s) from a physical environment at a display of the device) and holding the HIPD 2242. In the third AR system 2200c, the wrist-wearable device 2226, the MR device 2232, and/or the HIPD 2242 are used to interact within an MR environment, such as a VR game or other MR/VR application. While the MR device 2232 presents a representation of a VR game (e.g., first MR game environment 2220) to the user 2202, the wrist-wearable device 2226, the MR device 2232, and/or the HIPD 2242 detect and coordinate one or more user inputs to allow the user 2202 to interact with the VR game.

In some embodiments, the user 2202 can provide a user input via the wrist-wearable device 2226, the MR device 2232, and/or the HIPD 2242 that causes an action in a corresponding MR environment. For example, the user 2202 in the third MR system 2200c (shown in FIG. 22C-1) raises the HIPD 2242 to prepare for a swing in the first MR game environment 2220. The MR device 2232, responsive to the user 2202 raising the HIPD 2242, causes the MR representation of the user 2222 to perform a similar action (e.g., raise a virtual object, such as a virtual sword 2224). In some embodiments, each device uses respective sensor data and/or image data to detect the user input and provide an accurate representation of the user 2202's motion. For example, image sensors (e.g., SLAM cameras or other cameras) of the HIPD 2242 can be used to detect a position of the HIPD 2242 relative to the user 2202's body such that the virtual object can be positioned appropriately within the first MR game environment 2220; sensor data from the wrist-wearable device 2226 can be used to detect a velocity at which the user 2202 raises the HIPD 2242 such that the MR representation of the user 2222 and the virtual sword 2224 are synchronized with the user 2202's movements; and image sensors of the MR device 2232 can be used to represent the user 2202's body, boundary conditions, or real-world objects within the first MR game environment 2220.

In FIG. 22C-2, the user 2202 performs a downward swing while holding the HIPD 2242. The user 2202's downward swing is detected by the wrist-wearable device 2226, the MR device 2232, and/or the HIPD 2242 and a corresponding action is performed in the first MR game environment 2220. In some embodiments, the data captured by each device is used to improve the user's experience within the MR environment. For example, sensor data of the wrist-wearable device 2226 can be used to determine a speed and/or force at which the downward swing is performed and image sensors of the HIPD 2242 and/or the MR device 2232 can be used to determine a location of the swing and how it should be represented in the first MR game environment 2220, which, in turn, can be used as inputs for the MR environment (e.g., game mechanics, which can use detected speed, force, locations, and/or aspects of the user 2202's actions to classify a user's inputs (e.g., user performs a light strike, hard strike, critical strike, glancing strike, miss) or calculate an output (e.g., amount of damage)).

FIG. 22C-2 further illustrates that a portion of the physical environment is reconstructed and displayed at a display of the MR device 2232 while the MR game environment 2220 is being displayed. In this instance, a reconstruction of the physical environment 2246 is displayed in place of a portion of the MR game environment 2220 when object(s) in the physical environment are potentially in the path of the user (e.g., a collision with the user and an object in the physical environment are likely). Thus, this example MR game environment 2220 includes (i) an immersive VR portion 2248 (e.g., an environment that does not have a corollary counterpart in a nearby physical environment) and (ii) a reconstruction of the physical environment 2246 (e.g., table 2250 and cup 2252). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 2226, the MR device 2232, and/or the HIPD 2242 are described as detecting user inputs, in some embodiments, user inputs are detected at a single device (with the single device being responsible for distributing signals to the other devices for performing the user input). For example, the HIPD 2242 can operate an application for generating the first MR game environment 2220 and provide the MR device 2232 with corresponding data for causing the presentation of the first MR game environment 2220, as well as detect the user 2202's movements (while holding the HIPD 2242) to cause the performance of corresponding actions within the first MR game environment 2220. Additionally or alternatively, in some embodiments, operational data (e.g., sensor data, image data, application data, device data, and/or other data) of one or more devices is provided to a single device (e.g., the HIPD 2242) to process the operational data and cause respective devices to perform an action associated with processed operational data.

In some embodiments, the user 2202 can wear a wrist-wearable device 2226, wear an MR device 2232, wear smart textile-based garments 2238 (e.g., wearable haptic gloves), and/or hold an HIPD 2242 device. In this embodiment, the wrist-wearable device 2226, the MR device 2232, and/or the smart textile-based garments 2238 are used to interact within an MR environment (e.g., any AR or MR system described above in reference to FIGS. 22A-22B). While the MR device 2232 presents a representation of an MR game (e.g., second MR game environment 2220) to the user 2202, the wrist-wearable device 2226, the MR device 2232, and/or the smart textile-based garments 2238 detect and coordinate one or more user inputs to allow the user 2202 to interact with the MR environment.

In some embodiments, the user 2202 can provide a user input via the wrist-wearable device 2226, an HIPD 2242, the MR device 2232, and/or the smart textile-based garments 2238 that causes an action in a corresponding MR environment. In some embodiments, each device uses respective sensor data and/or image data to detect the user input and provide an accurate representation of the user 2202's motion. While four different input devices are shown (e.g., a wrist-wearable device 2226, an MR device 2232, an HIPD 2242, and a smart textile-based garment 2238) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 2238) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 2238 can be used in conjunction with an MR device and/or an HIPD 2242.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 22A-22C-2 provided above are intended to augment the description provided in reference to FIGS. 1-21. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

Plural instances may be provided for components, operations or structures described herein as a single instance. Finally, boundaries between various components, operations, and data stores are somewhat arbitrary, and particular operations are illustrated in the context of specific illustrative configurations. Other forms of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first layer could be termed a second layer, and, similarly, a second layer could be termed a first layer, without departing from the scope of the present disclosure. The first layer and the layer are both layers, but they are not the same layer.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case constraints, and that these specific goals will vary from one implementation to another and from one designer to another. Moreover, it will be appreciated that such a design effort might be complex and time-consuming, but nevertheless be a routine undertaking of engineering for those of ordering skill in the art having the benefit of the present disclosure.

For convenience in explanation and accurate definition in the appended claims, the terms “upper,” “lower,” “up,” “down,” “upwards,” “downwards,” “laterally,” “longitudinally,” “inner,” “outer,” “inside,” “outside,” “inwardly,” “outwardly,” “interior,” “exterior,” “front,” “rear,” “back,” “forwards,” and “backwards” are used to describe features of the exemplary embodiments with reference to the positions of such features as displayed in the figures.

Terminology surrounding extended-reality devices can change, and as such this application uses terms that in some instances can be interchangeable with other terms. While not limiting in nature, some alternative definitions are included herein. This application uses the term “Artificial Reality” to be a catchall term covering virtual reality (VR), augmented reality, mixed artificial reality (MAR), however, the term “extended-reality” can be used in place of “artificial reality” as a catchall term. The term augmented reality falls under the extended-reality catchall umbrella. The terms virtual-reality and mixed artificial reality, in some instances, can be replaced by the broader term “mixed-reality” commonly referred to as “MR,” and also fall under the extended-reality catchall umbrella. This MR term is meant to cover all extended-reality experiences that do not include a direct viewing of the surrounding environment, which can include virtual reality, virtual-realities that have the surrounding environment presented to the user indirectly from data acquired from sensors of the device (e.g., SLAM cameras, cameras, ToF sensors, etc.). Augmented reality includes directly viewing the surrounding environment, e.g., through a waveguide or a lens.

Furthermore, when a reference number is given an “i^{th}” denotation, the reference number refers to a generic component, set, or embodiment. For instance, a circuit component “circuit component i” refers to the i^{th} circuit component in a plurality of circuit components (e.g., a circuit component 200-i in a plurality of circuit components 200).

As used herein, the term “deformable substrate” refers to a substrate or a portion of it (e.g., a layer) capable of altering its shape subject to pressure or stress.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

1. A temple arm of a pair of smart glasses, comprising:
a battery disposed within a cavity of the temple arm;
a cover that encloses the battery located within the cavity of the temple arm; and
a seal that at least partially secures the cover to the temple arm and is configured to prevent moisture and debris ingress into the cavity, wherein the seal comprises:
an adhesive section that couples the cover and the temple arm; and
a reusable gasket section removably coupled to the cover and the temple arm, wherein the gasket section is configured to facilitate removal of the cover from the temple arm for replacing the battery.

2. The temple arm of claim 1, wherein the adhesive section is disposed around a section of a perimeter of the cover other than the gasket section that facilitates removal of the cover.

3. The temple arm of claim 1, wherein the gasket section that facilitates removal of the cover does not comprise an adhesive.

4. The temple arm of claim 1, wherein the seal is recessed within the temple arm at the gasket section that is configured to facilitate removal of the cover such that a pry tool can be inserted into the section for aiding in removing the cover.

5. The temple arm of claim 1, wherein the cover is configured to be removed and attached at least 1,000 times before moisture and debris prevention of the seal is comprised.

6. The temple arm of claim 1, wherein the battery is configured to be removed after the cover is removed, such that a replacement battery can be installed.

7. The temple arm of claim 1, wherein the cover partially secures to the temple arm via a clip.

8. The temple arm of claim 1, wherein an indication is located on the cover indicating where to initiate removal of the battery.

9. The temple arm of claim 1, wherein the temple arm is configured to receive a tool at the gasket section that is reinforced to facilitate removal of the cover without damaging the temple arm or the cover.

10. The temple arm of claim 1, further comprising:
a first slot in a first region within the cavity of the temple arm configured to secure the battery within the cavity and to secure the cover to the temple arm.

11. The temple arm of claim 10, further comprising:
a second slot in a second region within the cavity of the temple arm also configured to secure the battery with the cavity and to secure the cover to the temple arm.

12. The temple arm of claim 11, wherein the battery includes one or more spring clips for interfacing with the first slot or the second slot.

13. The temple arm of claim 11, wherein the cover includes one or more notches for interfacing with the first slot or the second slot.

14. The temple arm of claim 1, wherein the battery is configured to be removed by:
pulling a tab, wherein the tab is a free end of a tape connected to the battery;
compressing a spring clip with the tab as the tab is pulled, disengaging the battery from the cavity in the temple arm; and
continuing to pull on the tab until the battery is removed from the cavity.

15. The temple arm of claim 1, wherein the cover is configured to operate between:
(i) an open state in which the cover does not apply sufficient force to the battery for securing a plurality of charging contacts within the cavity to the battery, wherein the battery is configured to contact the plurality of charging contacts to provide power to the pair of smart glasses;
(ii) a closed state in which the cover applies sufficient force to the battery for securing the plurality of charging contacts to the battery.

16. The temple arm of claim 15, wherein the charging contacts are spring loaded, such that the battery is ejected from the cavity of the temple arm when the cover is removed.

17. The temple arm of claim 1, wherein the cover includes a release latch comprising:
a slidable portion;
a flat spring connected to the slidable portion, wherein the flat spring is compressed when the slidable portion is moved; and
a protrusion that interacts with the temple arm and is connected to the flat spring such that when the flat spring is compressed, the protrusion moves relative to the temple arm to release the latch.

18. The temple arm of claim 17, wherein the slidable portion of the latch is configured to be operated by a finger or operated by a specialized tool.

19. (canceled)

20. A pair of smart glasses, comprising:
a temple arm comprising:
a battery disposed within a cavity of the temple arm;
a cover that encloses the battery located within the cavity of the temple arm; and
a seal that at least partially secures the cover to the temple arm and is configured to prevent moisture and debris ingress into the cavity, wherein the seal comprises:
an adhesive section that semi-permanently bonds the cover and the temple arm; and
a reusable gasket section removably coupled to the cover and the temple arm, wherein the gasket section is configured to facilitate removal of the cover from the temple arm for replacing the battery.

21. A pair of augmented-reality glasses, comprising:
a display configured to present an augmented-reality experience;
a temple arm comprising:
a battery disposed within a cavity of the temple arm, wherein the battery provides power to the display that is configured to present the augmented-reality experience;
a cover that encloses the battery located within the cavity of the temple arm; and
a seal that at least partially secures the cover to the temple arm and is configured to prevent moisture and debris ingress into the cavity, wherein the seal comprises:
an adhesive section that semi-permanently bonds the cover and the temple arm; and
a reusable gasket section removably coupled to the cover and the temple arm, wherein the gasket section is configured to facilitate removal of the cover from the temple arm for replacing the battery.
